(19) United States
(12) Patent Application Publication
(10) Pub. No.: US 2018/0299884 A1
(43) Pub. Date: Oct. 18, 2018

(54) SERVER DEVICE, VEHICLE CONTROL DEVICE, AND WALKING ASSISTANCE DEVICE

(71) Applicant: KYOCERA CORPORATION, Kyoto (JP)

(72) Inventor: Kugo MORITA, Yokohama-shi (JP)

(73) Assignee: KYOCERA CORPORATION, Kyoto (JP)

(21) Appl. No.: 16/015,368

(22) Filed: Jun. 22, 2018

Related U.S. Application Data
(63) Continuation of application No. PCT/JP2016/088583, filed on Dec. 22, 2016.
(60) Provisional application No. 62/387,339, filed on Dec. 23, 2015.

(51) Int. Cl. G05D 1/00; G08G 1/09; G07C 5/08; G05D 1/02

(52) U.S. Cl. CPC G05D 1/0027; G08G 1/09; G05D 1/0289; G05D 1/0022; G07C 5/0816

(57) ABSTRACT

A server device according to one embodiment performs communication with a plurality of vehicles having an automatic driving function through a network. The server device comprises a processor configured to assign an area on a road to be traveled by automatic driving to each vehicle as an occupied area. The processor is further configured to: determine whether the vehicle is a traffic-obstructing vehicle that becomes an obstacle to traveling according to the assignment of the occupied area, based on information notified from the vehicle and/or another vehicle traveling around the vehicle, and perform a process corresponding to the obstacle in response to determining that the vehicle is the traffic-obstructing vehicle.

### CROSS-REFERENCE TO RELATED APPLICATION

The present application is a continuation based on PCT Application No. PCT/JP2016/088583 filed on Dec. 22, 2016, which claims the benefit of U.S. Patent Provisional Application No. 62/387,339 (filed on Dec. 23, 2015), the entire contents of which are incorporated herein by reference.

### FIELD

The present disclosure relates to a server device, a vehicle control device, and a walking assistance device for a road transportation system.

### BACKGROUND

Driving of an automobile is basically carried out by using an accelerator, a brake, and a steering wheel. A driver drives an automobile by controlling them. When considering traveling to a destination to which you are going for the first time, the driver has conventionally confirmed and memorized a route to the destination on a map in advance, and then performed driving to the destination based on the memory. Alternatively, a driver had a passenger see a map, and drove to a destination according to the instructions of the passenger.

On the other hand, at present, a driver can drive to a destination according to instructions of a navigation system (see Patent Literature 1: JP 6-194181 A). The navigation system searches for a route to a destination set in advance on map data, which is converted into digital data, from current position information acquired by a position information acquisition means such as a Global Navigation Satellite System (GNSS). Based on the search result, the navigation system sequentially issues an instruction corresponding to the current position to the driver. The driver can arrive at the destination by driving according to the instruction. Therefore, the driver can arrive at the destination, without spending effort to grasp the driving route in advance or without a passenger who has to spend effort to check the map and give the instruction.

However, until now, it was necessary for a person having a driving skill to board a vehicle in the first place. Regarding this problem, recent research has been actively conducted on automatic driving (see Non Patent Literature 1: Shinomura Rinko “DI-1-2 Recent Trends in Automatic Driving and Driving Assist Technology” 2014 The Institute of Electronics, Information and Communication Engineers General Convention).

The automatic driving is a technique for autonomously driving a vehicle to a destination by successively grasping circumstances of the vehicle by various sensors such as a radar and/or a camera mounted on the vehicle, without intervention of a human's hand. In this manner, the passenger can move to the destination simply by setting the destination, without requiring the effort of the act of driving itself, and furthermore, without requiring the effort of learning the driving skill.

On the other hand, there is traffic congestion as a problem in road traffic. There are various causes of traffic congestion, for example, “traffic congestion (1) caused by a speed decreasing unintentionally as a result of keeping stepping on the same way without noticing a change to an uphill road”, “traffic congestion (2) where a vehicle (right turn vehicle) attempting to make a right turn is blocked by an oncoming vehicle and waits for a right turn, and a following vehicle of the right turn vehicle cannot pull out the right turn vehicle”, “traffic congestion (3) due to signal waiting”, “traffic congestion (4) caused by temporary concentration of vehicles on narrow roads”, and the like. As a mechanism of occurrence of such traffic congestion, it is considered that traffic congestion is caused by a decrease or stop of the speed of the vehicle traveling at the head due to some causes.

The above-mentioned traffic congestion (1) is a traffic congestion caused because the driver did not notice the change of situation due to visual misrecognition and operated as before. Therefore, in automatic driving that drives while checking a vehicle speed at any time, there is a possibility that traffic congestion (1) will be reduced.

On the other hand, at present, road conditions are collected with vehicle sensors installed on the roadside, and road information such as congestion based on this information is provided to each vehicle through FM multiplex broadcasting or road-to-vehicle communication such as beacon (VICS (registered trademark): Vehicle Information and Communication System). Each vehicle can select a route avoiding a congested road by considering the route to the destination based on the road information.

In addition, vehicle-to-vehicle (V2V) communication that directly transmits and receives information between vehicles has recently been studied. In the vehicle-to-vehicle communication, for example, it is thought that vehicle information such as the speed and position of the vehicle can be transmitted and received. Therefore, even if the speeds of some preceding vehicles are lowered for some reasons, it is possible to immediately receive information on the speed reduction from the preceding vehicles and warn the driver. Therefore, it is considered that the driver can respond to the speed reduction before the speed reduction of the immediately preceding vehicle occurs.

### SUMMARY

A server device according to one embodiment performs communication with a plurality of vehicles having an automatic driving function through a network. The server device comprises a processor configured to assign an area on a road to be traveled by automatic driving to each vehicle as an occupied area. The processor is further configured to: determine whether the vehicle is a traffic-obstructing vehicle that becomes an obstacle to traveling according to the assignment of the occupied area, based on information notified from the vehicle and/or another vehicle traveling around the vehicle, and perform a process corresponding to the obstacle in response to determining that the vehicle is the traffic-obstructing vehicle.

A vehicle control device according to one embodiment is provided in a vehicle having an automatic driving function and controls the vehicle. The vehicle control device comprises a communication unit configured to perform communication with a server device through a network; and a processor configured to detect another vehicle which becomes an obstacle to traveling according to an assignment of an occupied area from the server device. The occupied area is an area on a road to be traveled by automatic driving. The processor notifies the server device of information about the other vehicle.

A walking assistance device according to one embodiment comprises a walking assistance power unit configured to assist a walking of a user; a communication unit configured to perform communication with a server device through a network; and a processor configured to acquire, from the server device, assignment information indicating an area on a road on which a vehicle travels by automatic driving. The processor predicts a movement of the user. The processor determining whether the user contacts the vehicle based on the prediction result of the movement and the assignment information. In response to determining that the user will contact the vehicle, the processor controls the walk assistance power unit so that the user will not contact the vehicle, and/or performs notification to the vehicle.

### BRIEF DESCRIPTION OF DRAWINGS

FIG. 1 is a configuration diagram of a system according to a first embodiment.

FIG. 2 is a diagram illustrating an example of a configuration of a vehicle according to the first embodiment.

FIG. 3 is a diagram illustrating an example of a configuration of a route assignment server according to the first embodiment.

FIG. 4 is a diagram illustrating an example of a configuration of a charging server according to the first embodiment.

FIG. 5 is a diagram illustrating an example of a configuration of a weather information server according to the first embodiment.

FIG. 6 is a diagram illustrating an example of a flow of movement setting according to the first embodiment.

FIG. 7 is a diagram illustrating an example of a flowchart of updating a vehicle information storage unit according to the first embodiment.

FIG. 8 illustrates an example of a flowchart in a vehicle body upon a driving request according to the first embodiment.

FIG. 9 illustrates an example of a flowchart in a route assignment server upon a driving request according to the first embodiment.

FIGS. 10A to 10D are diagrams illustrating occupied area for each height according to the first embodiment.

FIGS. 11A to 11B are diagrams illustrating examples of setting of an occupied area by wind pressure according to the first embodiment.

FIGS. 12A to 12B are diagrams illustrating road use in the case of absence of wind pressure according to the first embodiment.

FIGS. 13A to 13B are diagrams illustrating road use in the case of presence of wind pressure according to the first embodiment.

FIGS. 14A to 14B are diagrams illustrating examples of setting of an occupied area by aged deterioration according to the first embodiment.

FIGS. 15A to 15C are diagrams illustrating examples of setting of an occupied area by a road surface condition according to the first embodiment.

FIG. 16 is a flowchart of a vehicle upon abnormality detection according to the first embodiment.

FIG. 17 is a flowchart of a route assignment server upon reception of a stop request according to the first embodiment.

FIGS. 18A to 18C are diagrams illustrating abnormal vehicle detection according to the first embodiment.

FIG. 19 is a diagram illustrating an example of a flow of abnormal vehicle detection according to the first embodiment.

FIG. 20 is a flowchart of a vehicle upon position measurement of a nearby vehicle according to the first embodiment.

FIG. 21 is a flowchart of a route assignment server upon reception of an abnormal vehicle notification according to the first embodiment.

FIG. 22 is a diagram illustrating an example of a setting of an occupied area of an abnormal vehicle according to the first embodiment.

FIG. 23 is a flowchart of a route assignment server with respect to a parked/stopped vehicle according to the first embodiment.

FIGS. 24A to 24B are diagrams illustrating determination of a traffic trouble of a parked/stopped vehicle according to the first embodiment.

FIGS. 25A to 25B are diagrams illustrating determination of a traffic trouble of a parked/stopped vehicle according to the first embodiment.

FIG. 26 is a flowchart of a vehicle in acquiring vehicle identification information according to the first embodiment.

FIG. 27 is a diagram illustrating transmission of route assignment information according to the first embodiment.

FIG. 28 is a diagram illustrating acquisition of notification information of a nearby vehicle according to the first embodiment.

FIG. 29 is a configuration diagram of a system according to a second embodiment.

FIG. 30 is a diagram illustrating an example of a configuration of a walking assistance device according to the second embodiment.

FIG. 31 is a diagram illustrating an example of a configuration of a vehicle according to the second embodiment.

FIG. 32 is a diagram illustrating an example of a configuration of a route assignment server according to the second embodiment.

FIG. 33 is a diagram illustrating an example of a flow of vehicle contact avoidance of the walking assistance device according to the second embodiment.

FIG. 34 illustrates an example of a flowchart of avoidance processing of the walking assistance device according to the second embodiment.

FIG. 35 illustrates an example of a flowchart of selection of an avoidance method of the walking assistance device according to the second embodiment.

FIGS. 36A to 36D are diagrams illustrating examples of avoidance methods according to the second embodiment.

FIG. 37 is a diagram illustrating an example of a state transition diagram of a transmission permission/prohibition state according to the second embodiment.

FIG. 38 illustrates an example of a flowchart of a vehicle upon walking assistance device avoidance processing according to the second embodiment.

FIG. 39 illustrates an example of a flowchart of a route assignment server upon walking assistance device avoidance processing according to the second embodiment.

FIG. 40 is a diagram illustrating an example of an application range according to the second embodiment.

FIG. 41 is a diagram illustrating an example of an application range according to the second embodiment.

FIG. 42 is a diagram illustrating an example of a risk level according to the second embodiment.

FIG. 43 is a diagram illustrating an example of operation restriction according to the second embodiment.

FIG. 44 is a diagram illustrating an example of operation restriction according to the second embodiment.

FIG. 45 is a diagram illustrating an example of an application range according to the second embodiment.

FIG. 46 is a diagram illustrating an example of a relationship between a vehicle situation and a width of a range according to the second embodiment.

FIG. 47 is a diagram illustrating an example of a relationship between a vehicle situation and a width of a range according to the second embodiment.

FIG. 48 is a diagram illustrating an example of a relationship of a width of a range according to the second embodiment.

FIG. 49 is a diagram illustrating an example of an application range according to the second embodiment.

FIGS. 50A to 50C are diagrams illustrating examples of a restraint unit and a damage reduction unit according to the second embodiment.

FIGS. 51A to 51B are diagrams illustrating examples of a vehicle body color according to the second embodiment.

FIGS. 52A to 52B are diagrams illustrating examples of passenger seat control according to the second embodiment.

FIGS. 53A to 53B are diagrams illustrating examples of band assignment according to the second embodiment.

FIGS. 54A to 54B are diagrams illustrating examples of band assignment according to the second embodiment.

FIGS. 55A to 55C are diagrams illustrating examples of transmission by band assignment according to the second embodiment.

### DESCRIPTION OF EMBODIMENTS

### First Embodiment

(Overview of First Embodiment)

As described above, the automatic driving is a technique in which individual vehicles autonomously determine the surroundings based on information acquired by sensors held in the individual vehicles and perform driving. However, for example, in the case of the traffic congestion (2), the oncoming vehicle is not necessarily limited to the right turn vehicle. Even when there is the vehicle that gives way to the road, if the right turn vehicle cannot determine that a safe right turn is possible, the right turn vehicle will not turn to the right. Also, in vehicle-to-vehicle communication, it is assumed that one oncoming vehicle urges the vehicle to turn right. However, if another oncoming vehicle makes a different determination, the right turn vehicle cannot determine that it can safely turn right and will not turn right. For example, in the case of the above-mentioned traffic congestion (4), traffic congestion is avoided based on traffic congestion information by road-to-vehicle communication. In this case, since each vehicle performs a traffic congestion avoidance behavior in the same manner, a place where the traffic congestion occurs is shifted to another place. Therefore, even in the automatic driving, it can be said that there is a problem of traffic congestion.

When considering the passage of an emergency vehicle such as an ambulance, no matter how heavy traffic, each vehicle makes the way to pass the emergency vehicle, and thus the emergency vehicle passes even in the traffic congestion. This means that there is still room on the road, and if a space can be used more effectively, there is a possibility of providing a more comfortable driving environment. In other words, in a current road use, there is a problem that the space cannot be used sufficiently efficiently.

To cope with such a problem, there is provided a transportation system including a vehicle that is connected to communicate with a network in radio communication and performs automatic driving, and a route assignment server that is connected to communicate with the vehicle through the network and calculates a traveling route of the vehicle. The route assignment server assigns a road area occupied by the vehicle for each minute time period to a destination of the vehicle, based on the destination from the vehicle, vehicle information, and road information. Each vehicle can make effective use of a road space by automatically driving the assigned road area at a synchronized timing based on a synchronization signal.

However, due to unexpected causes such as deterioration of parts, breakdown, or contamination around sensors, the automatically driven vehicles also have a risk of performing unexpected operations such as traveling differently from the road assignment by the route assignment server. The unexpected movements become obstacles on road traffic, and as a result, become a factor that hinders the provision of a comfortable driving environment by effectively utilizing the space of the road.

A server device according to a first embodiment performs communication with a plurality of vehicles having an automatic driving function through a network. The server device comprises a processor configured to assign an area on a road to be traveled by automatic driving to each vehicle as an occupied area. The processor is further configured to: determine whether the vehicle is a traffic-obstructing vehicle that becomes an obstacle to traveling according to the assignment of the occupied area, based on information notified from the vehicle and/or another vehicle traveling around the vehicle, and perform a process corresponding to the obstacle in response to determining that the vehicle is the traffic-obstructing vehicle.

For example, the server device estimates the influence on the traffic from the vehicle targeted for notification based on the notification from the vehicle or the nearby vehicle, and if it is determined that the vehicle is obstructive to traffic as a result of the estimation, urges to move to places with minimal impact as much as possible based on conditions of the vehicle. This makes it possible to realize a comfortable driving environment by effectively utilizing the space of the road even when there is a traffic-obstructing vehicle.

In the server device according to the first embodiment, the processor may determine that one vehicle is the traffic-obstructing vehicle in response to receiving, from the one vehicle, a notification indicating an abnormality detected by the one vehicle from self-diagnosis of the one vehicle.

In the server device according to the first embodiment, if the traffic-obstructing vehicle is stopped and parked, the processor may select an evacuation vehicle that evacuates a passenger of the traffic-obstructing vehicle from among other vehicles traveling around the traffic-obstructing vehicle.

In the server device according to the first embodiment, the processor may determine that another vehicle is the traffic-obstructing vehicle in response to receiving, from one vehicle, a notification indicating that the another vehicle traveling around the one vehicle is not traveling in the assigned road area.

In the server device according to the first embodiment, the processor may select a guide vehicle for guiding the traffic-obstructing vehicle from among other vehicles traveling around the traffic-obstructing vehicle.

In the server device according to the first embodiment, the processor may request a base station or a base station control device to set communication between the traffic-obstructing vehicle and the guide vehicle.

In the server device according to the first embodiment, the processor may receive, from one vehicle, identification information for identifying a parked/stopped vehicle parking or stopping on a road and information indicating a position of the parked/stopped vehicle, and if it is determined that the parked/stopped vehicle is the traffic-obstructing vehicle, the processor may instruct a movement of the parked/stopped vehicle.

In the server device according to the first embodiment, when the processor instructs the movement of the parked/stopped vehicle, the processor may notify a use reserving person or a final use person of the parked/stopped vehicle of a destination of the parked/stopped vehicle.

In the server device according to the first embodiment, the identification information may be a vehicle identifier notified by an RF-ID tag provided in the parked/stopped vehicle, or a vehicle identifier broadcast by the parked/stopped vehicle by vehicle-to-vehicle communication.

In the server device according to the first embodiment, the processor may reserve a radio resource used for notifying the occupied area assigned to each vehicle to a base station or a base station control device. The processor may notify the respective vehicles of the reserved radio communication resource.

A vehicle control device according to the first embodiment is provided in a vehicle having an automatic driving function and controls the vehicle. The vehicle control device comprises a communication unit configured to perform communication with a server device through a network; and a processor configured to detect another vehicle which becomes an obstacle to traveling according to an assignment of an occupied area from the server device. The occupied area is an area on a road to be traveled by automatic driving. The processor notifies the server device of information about the other vehicle.

In the server device according to the first embodiment, the processor may acquire, from the server device, information indicating assignment of an occupied area of a vehicle around the vehicle. The processor may measure a position of the surrounding vehicle. If it is determined that the surrounding vehicle is not traveling in the occupied area, the processor may notify the server device of information about the surrounding vehicle.

In the server device according to the first embodiment, the processor may notify the server device of identification information for identifying a parked/stopped vehicle parking or stopping on a road and information indicating a position of the parked/stopped vehicle.

(System Configuration)

FIG. 1 is a diagram illustrating a configuration of a system according to a first embodiment.

As illustrated in FIG. 1, a vehicle 100 radio-communicates with a base station 400. The base station 400, a route assignment server 200, a charging server 300, and a weather information server 600 communicate with one another through a network 500. The vehicle 100 transmits a request for traveling (travel request) to the route assignment server 200 through the base station 400 and the network 500. The route assignment server 200 calculates the route assignment of each vehicle 100 based on the travel request and the previously received travel request of another vehicle 100. The route assignment server 200 transmits the route assignment to each vehicle 100 as necessary.

A route assignment server 200 acquires weather information from the weather information server 600. In addition, the route assignment server 200 acquires vehicle information from the vehicle 100. The route assignment server 200 acquires environmental information measured by the vehicle 100. The route assignment server 200 calculates route assignment of each vehicle 100 by taking into account the weather information, the vehicle information, and the environmental information. The vehicle 100 is an automatically driven vehicle and travels according to the route assignment.

Charging may be made for the route assignment. In this case, the route assignment server 200 determines whether charging is generated for a travel request from the vehicle 100. When the route assignment server 200 determines that the charging is generated, the route assignment server 200 notifies the vehicle 100 of that effect. The vehicle 100 notifies the route assignment server 200 of approval or rejection of the charging, and if a response for the notification of the vehicle 100 is the approval, the route assignment server 200 notifies the charging server 300 of the charging and fixes the route assignment.

The vehicle 100 notifies the route assignment server 200 of the report and/or the request associated with the detection of the abnormality through the base station 400 and the network 500. The route assignment server 200 performs correspondence based on the report and/or the request. The route assignment server 200 issues an instruction to the related vehicle 100 through the network 500 and the base station 400. In addition, for communication accompanying the correspondence, a temporary request for a communication means (communication resource or the like) for communication between vehicles is made to the control server that controls the base station 400 or the base station 400. The route assignment server 200 notifies the corresponding vehicle 100 of the acquired communication means.

(Configuration of Vehicle)

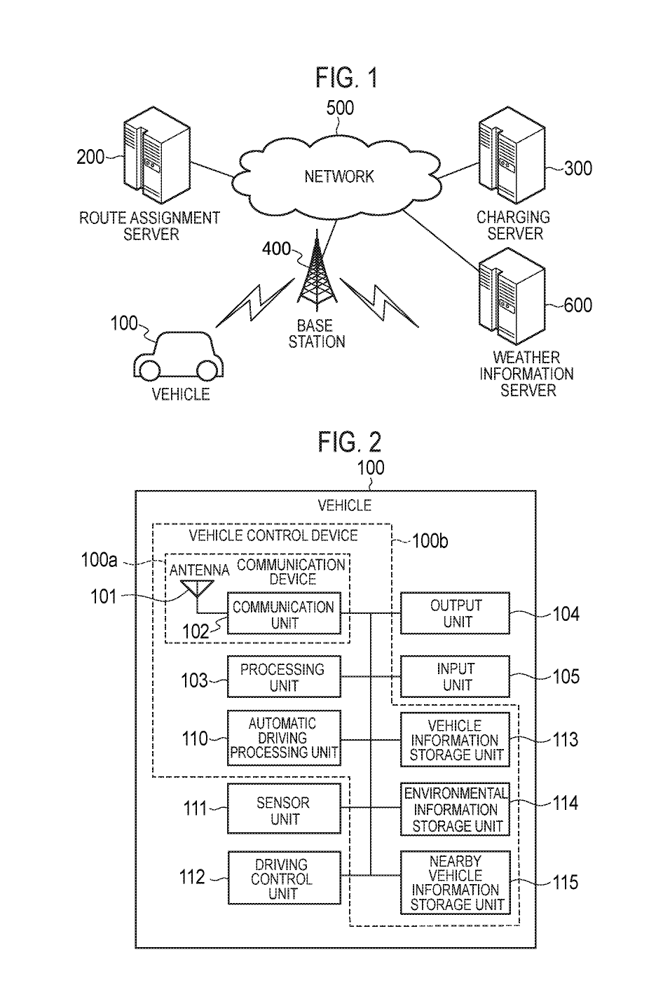

FIG. 2 is a diagram illustrating an example of the configuration of the vehicle 100 according to an embodiment.

As illustrated in FIG. 2, the vehicle 100 includes an antenna 101, a communication unit 102, a processing unit 103, an output unit 104, an input unit 105, an automatic driving processing unit 110, a sensor unit 111, and a driving control unit 112, a vehicle information storage unit 113, an environmental information storage unit 114, and a nearby vehicle information storage unit 115. The communication unit 102 is radio-connected to the base station 400 through the antenna 101. The output unit 104 outputs an image and/or a sound to passengers (a driver and a fellow passenger). The input unit 105 receives a voice input from a passenger and an operation input of a touch panel or the like. The automatic driving processing unit 110 performs processing in automatic driving. The sensor unit 111 includes a sensor for measurement outside the vehicle, such as a camera and/or a radar, and a sensor for measurement inside the vehicle, such as a vehicle speed, a position, and a weight. The driving control unit 112 controls the traveling of the vehicle 100 based on driving operations such as an accelerator, a brake, and a steering. The vehicle information storage unit 113 stores the vehicle information including information about objects (components) constituting the vehicle, such as vehicle type, history of components, software version information, and the like. The environmental information storage unit 114 stores the environmental information measured by sensors. The nearby vehicle information storage unit 115 stores information of a nearby vehicle.

The antenna 101 and the communication unit 102 constitute a communication device 100a provided in the vehicle. The communication device 100a may further include a processing unit 103. The communication device 100a, the processing unit 103, the automatic driving processing unit 110, the vehicle information storage unit 113, the environmental information storage unit 114, and the nearby vehicle information storage unit 115 constitute a vehicle control device 100b that controls the vehicle. The vehicle control device 100b may further include an output unit 104 and an input unit 105. The operation of the vehicle described below is controlled by the vehicle control device 100b.

The passenger inputs, to the input unit 105, a request such as movement to a destination, air conditioning, or music. If the request is a travel request, the processing unit 103 transmits the travel request to the route assignment server 200 through the communication unit 102. In the case of a request other than the travel request, the processing unit 103 activates a corresponding function in the vehicle. The processing unit 103 receives a notification from the route assignment server 200 through the communication unit 102. When the notification is a notification related to automatic driving, the processing unit 103 notifies the automatic driving processing unit 110 of this notification. If the notification is information about the nearby vehicle, the processing unit 103 holds the notification in the nearby vehicle information storage unit 115. Also, when the notification includes information that needs to be notified to the passenger, the processing unit 103 outputs the information to the passenger through the output unit 104.

The automatic driving processing unit 110 issues instructions for an accelerator, a brake, and a steering to the driving control unit 112, based on the information about the automatic driving received from the processing unit 103 and the acquisition result from the sensor unit 111, and controls the traveling of the vehicle 100. The automatic driving processing unit 110 notifies the processing unit 103 of a part or the whole of the measurement result acquired by the sensor unit 111. The processing unit 103 notifies a part of the measurement result, for example, a road surface condition and/or a vehicle body condition, to the route assignment server 200 through the communication unit 102.

The vehicle information storage unit 113 holds, for example, a model number of the vehicle, a replacement history of the components, an abrasion condition, a model number of the software of the automatic driving processing, a version, and the like as the information about the components constituting the vehicle. An automatic driving processing unit 110 transmits, to the route assignment server 200, the vehicle information held in the vehicle information storage unit 113 according to the instruction of the route assignment server 200.

The environmental information storage unit 114 stores environmental information around the vehicle, such as a temperature, a pressure, a humidity, a wind direction, a wind pressure, a rainfall, a snow cover, a road surface condition (irregularity information, flooding, snow cover, frozen state), an image, a video, together with a measurement time and a measurement position. The automatic driving processing unit 110 measures each environmental information at each timing according to the instruction of the route assignment server 200, and holds the environmental information in the environmental information storage unit 114. The automatic driving processing unit 110 transmits the environmental information stored in the environmental information storage unit 114 to the route assignment server 200 based on the instructed timing.

The vehicle 100 is synchronized with a timing based on a signal from a GNSS and a signal from the base station 400. The vehicle 100 notifies the route assignment server 200 of the level and position of synchronization. The vehicle 100 checks the position on the road based on the result of measuring the road by using the sensor together with the position information by the GNSS. The vehicle 100 travels to the position designated by the route assignment server 200. When the road is measured by using the sensor, the vehicle 100 detects and grasps a painted line on the road, such as a shoulder, a median strip, or a white line, by using a camera, a distance sensor or the like. Alternatively, at the time of creating the road, numerous magnetic substances are mixed into the asphalt or cement and spread on the road. The vehicle 100 stores a combination of magnetic substance arrangement pattern and position. At the time of traveling, the vehicle 100 reads the arrangement pattern of the magnetic substances around the lower portion of the vehicle body of the vehicle 100 by using the sensor. The vehicle 100 specifies the position based on the read arrangement pattern.

The automatic driving processing unit 110 performs internal diagnosis and, if an abnormality is detected, notifies the route assignment server 200 of information corresponding to the abnormality. The vehicle 100 measures a vehicle traveling in the vicinity by the sensor unit 111, compares the measurement result with the route assignment of the nearby vehicle, and notifies the route assignment server 200 based on the comparison result. The route assignment of the nearby vehicle is assigned by the route assignment server 200 and is held in the nearby vehicle information storage unit 115. In addition, the automatic driving processing unit 110 acquires the identifier of the nearby vehicle and notifies the route assignment server 200 of the identifier of the nearby vehicle together with the position information of the nearby vehicle according to the situation.

If the vehicle 100 receives an instruction to guide the nearby vehicle from the route assignment server 200, the vehicle 100 guides the nearby vehicle by using a communication means based on the instruction. For example, while the sensor unit 111 measures the position of the nearby vehicle, the sensor unit 111 transmits a driving control signal to the nearby vehicle, instead of the automatic driving processing unit of the nearby vehicle.

(Configuration of Route Assignment Server)

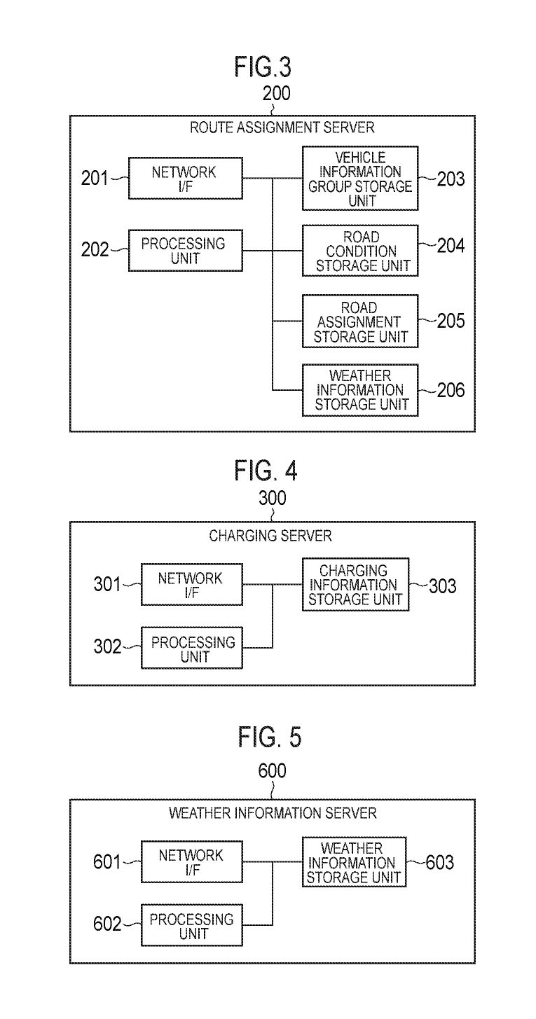

FIG. 3 is a diagram illustrating an example of the configuration of the route assignment server 200 according to an embodiment.

As illustrated in FIG. 3, the route assignment server 200 includes a network I/F 201, a processing unit 202, a vehicle information group storage unit 203, a road condition storage unit 204, a road assignment storage unit 205, and a weather information storage unit 206. The network I/F 201 is connected so as to communicate with the network 500. The vehicle information group storage unit 203 stores information about each vehicle. The road condition storage unit 204 stores the road surface condition of the road and the like. The road assignment storage unit 205 stores the assignment of the road to the vehicle. The weather information storage unit 206 stores weather information.

The processing unit 202 performs communication with the vehicle 100, the charging server 300, and the weather information server 600 through the network I/F unit 201.

The processing unit 202 stores, in the vehicle information group storage unit 203, the travel request from the vehicle 100 and/or the vehicle condition.

The processing unit 202 stores, in the road condition storage unit 204, the road surface condition acquired from the vehicle 100 and/or a road management device disposed on the road side.

The processing unit 202 acquires weather information from the weather information server 600, acquires environmental information from the vehicle 100, and stores the acquired information in the weather information storage unit 206.

The processing unit 202 performs the assignment of the road (road area) based on the information held in the vehicle information group storage unit 203, the information held in the road condition storage unit 204, and the environmental information and the weather information held in the weather information storage unit 206. The processing unit 202 stores the road area assignment result (road assignment) in the road assignment storage unit 205. The processing unit 202 notifies the vehicle 100 of the road assignment in the vehicle 100 through the network I/F 201. The road assignment notified to the vehicle 100 is route assignment information (road assignment information) composed of a road area assigned to only one vehicle 100 in a minute period (minute time period). The minute period is a period (for example, 1 ms) that becomes controllable based on the synchronization of the vehicle 100 and a manual driving requesting vehicle 160.

In the assignment of the route of the vehicle 100, if there are priorities in the vehicles, the processing unit 202 first assigns the road area with respect to the traveling route of the vehicle having the high priority. In the case of vehicles having the same priority, the processing unit 202 compares the traveling routes of the respective vehicles 100. As a result of the comparison, if the vehicle travels on the same route section, the processing unit 202 assigns the road area from the vehicle 100 traveling ahead in time on the same route.

The route assignment server 200 (processing unit 202) determines a minute period of the position based on the position acquired from the vehicle 100 and the accuracy of synchronization corresponding to the position. The accuracy of the synchronization timing if the notification signal of the base station 400 can be received is different from the accuracy of the synchronization timing if only the GNSS can be received. For example, in the case based on the notification signal of the base station 400, the route assignment server 200 sets the minute period to be small (for example, 1 ms). On the other hand, in the case based on only the GNSS, the route assignment server 200 sets the minute period to be large (for example, 1 sec). If the length of the minute period is switched, the route assignment server 200 sets the length of the minute period to gradually change.

If the route assignment server 200 (the processing unit 202) receives the notification accompanying the abnormality of the vehicle 100, the processing unit 202 determines the destination of the vehicle 100 based on the notification that there is the abnormality. The route assignment server 200 performs the route assignment processing according to the determined destination of the vehicle. In addition, the route assignment server 200 requests repair.

According to the situation, the route assignment server 200 requests the nearby traveling vehicle of the vehicle, which has issued the notification of abnormality, to operate as an evacuation vehicle, and notifies a transfer instruction or the like accompanying this request. If the notification accompanying the detection of the abnormality of the nearby vehicle is received, the route assignment server 200 determines the destination of the vehicle based on the notification and performs the route assignment processing accompanying the determination.

The route assignment server 200 (the processing unit 202) requests the nearby traveling vehicle to guide the vehicle according to the situation. In addition, the route assignment server 200 requests the base station 400 or the control server of the base station 400 to secure the communication means between the vehicle and the vehicle to be guided, and notifies the permitted communication means to the vehicle that issued the notification of abnormality and the vehicle to be guided.

According to the situation, the route assignment server 200 (the processing unit 202) requests the nearby traveling vehicle to operate as an evacuation vehicle, and notifies a transfer instruction or the like accompanying this request. If the notification of the parked/stopped vehicle is received, the route assignment server 200 determines the presence or absence of a future traffic trouble based on the notification and the road assignment of the road assignment storage unit 205. If it is determined that the traffic trouble occurs, the route assignment server 200 determines the destination of the parked/stopped vehicle and performs the route assignment processing.

(Configuration of Charging Server)

FIG. 4 is a diagram illustrating an example of the configuration of the charging server 300 according to an embodiment.

As illustrated in FIG. 4, the charging server 300 includes a network I/F unit 301, a processing unit 302, and a charging information storage unit 303. The network I/F unit 301 is connected to communicate with the network 500. The charging information storage unit 303 stores charging information about the vehicle 100.

The processing unit 302 receives a charging approval message through the network I/F 301. The processing unit 302 holds the charging approval message in the charging information storage unit 303. In addition, the processing unit 302 receives a message of performance information indicating that the payment of the charging has been fulfilled. The processing unit 302 determines the charging according to the message contents of the performance information corresponding to the charging information in the charging information storage unit 303. The processing unit 302 performs the processing of the information of the charging information storage unit 303 based on the payment request.

(Configuration of Weather Information Server)

FIG. 5 is a diagram illustrating an example of the configuration of the weather information server 600.

As illustrated in FIG. 5, the weather information server 600 includes a network I/F 601, a processing unit 602, and a weather information storage unit 603. The network I/F 601 is connected to communicate with the network 500. The weather information storage unit 603 stores weather information.

The processing unit 602 receives a weather information request through the network I/F 601. The processing unit 602 returns the weather information held in the weather information storage unit 603 in response to the weather information request. Alternatively, if there is weather information to be transmitted, the processing unit 602 notifies the weather information.

(Example of Flow of Movement Setting)

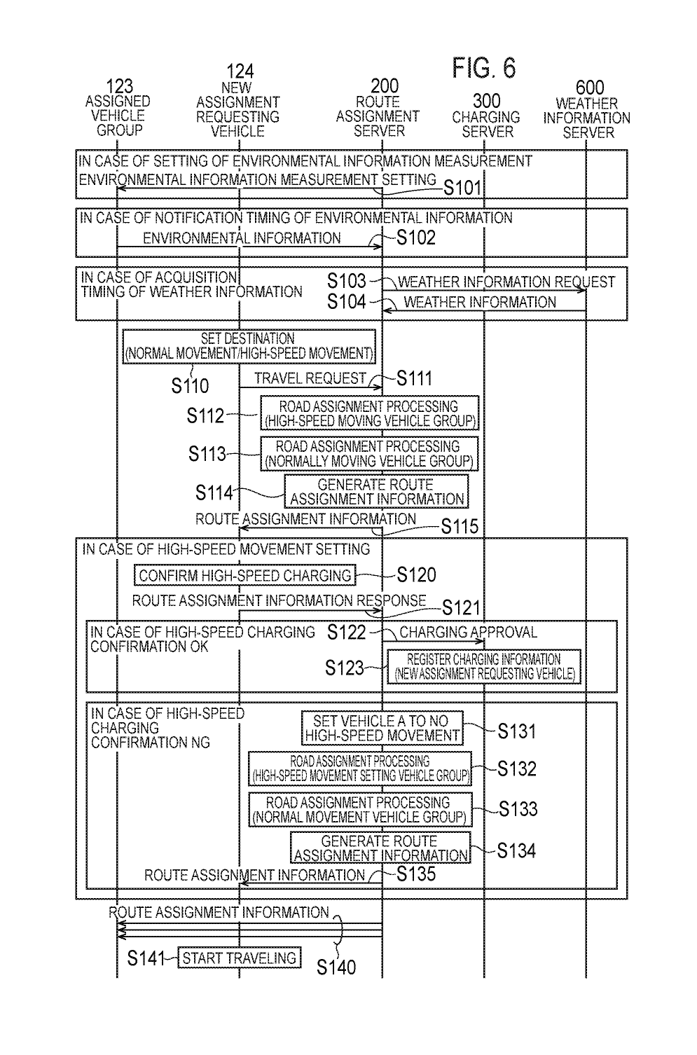

FIG. 6 illustrates an example of a flow of movement setting. The vehicles traveling on the road (the vehicle 100) are classified into a normal movement setting vehicle and a high-speed movement setting vehicle. The normal movement setting vehicle is a vehicle that pays only the charging that is originally required to travel on the road. The high-speed movement setting vehicle is a vehicle that is allowed to travel faster than the normal movement setting vehicle by paying an additional charging in addition to the charging that is originally required for traveling on the road. The assigned vehicle group 123 is a group of vehicles that have already received the route assignment and includes the normal movement setting vehicles and the high-speed movement setting vehicles. A new assignment requesting vehicle 124 is a vehicle to which the route assignment is to be made.

As illustrated in FIG. 6, the route assignment server 200 transmits an environmental information measurement setting to the vehicle determined to require a setting of environmental information measurement among the route-assigned vehicle group 123 (step S101). The vehicle having received the environmental information measurement setting starts measurement based on the environmental information measurement setting. If a notification timing of the environmental information measured based on the environmental information measurement setting arrives, the vehicle transmits the environmental information with the notification timing to the route assignment server 200 (step S102). The route assignment server 200 holds the received environmental information in the weather information storage unit 206.

If the route assignment server 200 determines that it is the timing when the weather information of the weather information server 600 is to be acquired, the route assignment server 200 transmits a weather information request to the weather information server 600 (step S103). The route assignment server 200 receives the weather information as a response to the weather information request (step S104), and holds the received weather information in the weather information storage unit 206.

In the new assignment requesting vehicle 124, the passenger operates the input unit 105 to set a destination and set “high-speed movement setting” or “normal movement setting” (step S110). The new assignment requesting vehicle 124 notifies the route assignment server 200 of the set request as the travel request (step S111). The travel request includes the vehicle information held in the vehicle information storage unit 113. The vehicle information includes information on components constituting the vehicle, such as a model number of the vehicle, a replacement history of the components, an abrasion situation, a model number of the software of the automatic driving processing, a version, and the like. The travel request includes measurement information. The measurement information is a weight, an occupied area for each height, and the like. The route assignment server 200 performs road assignment processing for the high-speed movement setting vehicle group based on the travel request, and the environmental information and the weather information stored in the weather information storage unit 206 (step S112). Similarly, the route assignment server 200 performs the road assignment processing of the normal movement setting vehicle group (step S113). The route assignment server 200 generates route assignment information of each vehicle (step S114). The route assignment server 200 notifies the route assignment information to the new assignment requesting vehicle 124 (step S115).

If the new assignment requesting vehicle 124 sets “high-speed movement setting” in the travel request, the new assignment requesting vehicle 124 outputs the received route assignment information through the output unit 104 to urge the passenger to confirm the charge. The passenger inputs the charge confirmation OK/NG through the input unit 105 (step S120). The new assignment requesting vehicle 124 transmits a route assignment information response including the charge confirmation to the route assignment server (step S121).

If the charge confirmation of the route assignment information response is OK, the route assignment server 200 notifies a charging approval message to the charging server 300 (step S122). The charging server 300 stores the charging information including the notified message in the charging information storage unit 303 (step S123).

If the charge confirmation of the route assignment information response is NG, the route assignment server 200 sets the travel request of the new assignment requesting vehicle 124 to “normal movement setting” (step S131). The route assignment server 200 performs the road assignment processing of the high-speed movement setting vehicle group (step S132). The route assignment server 200 performs the road assignment processing of the normal movement setting vehicle group (step S133). The route assignment server 200 generates route assignment information of each vehicle (step S134). The route assignment server 200 notifies the route assignment information to the new assignment requesting vehicle 124 (step S135). The route assignment server 200 notifies the route assignment information to the assigned vehicle group 123 (step S140). The new assignment requesting vehicle 124 starts traveling based on the received route assignment information (step S141).

Thus, the route assignment server 200 performs the road assignment processing based on the vehicle information such as the model number of the vehicle in each vehicle, the replacement history of the components, the abrasion condition, the model number of the software of the automatic driving processing, the version, or the like, and the vehicle body condition measured by the vehicle. Therefore, it is possible to assign roads according to the traveling performance of individual vehicles, thereby avoiding contact accidents and enabling the high effective use of the road space. Furthermore, the route assignment server 200 performs road assignment processing by taking into account weather information and/or environmental information. This makes it possible to assign roads in consideration of deterioration of the accuracy of travel control accompanying deterioration of the traveling environment, thereby increasing the utilization efficiency of the road space without causing a contact accident.

(Updating Flow of Vehicle Information)

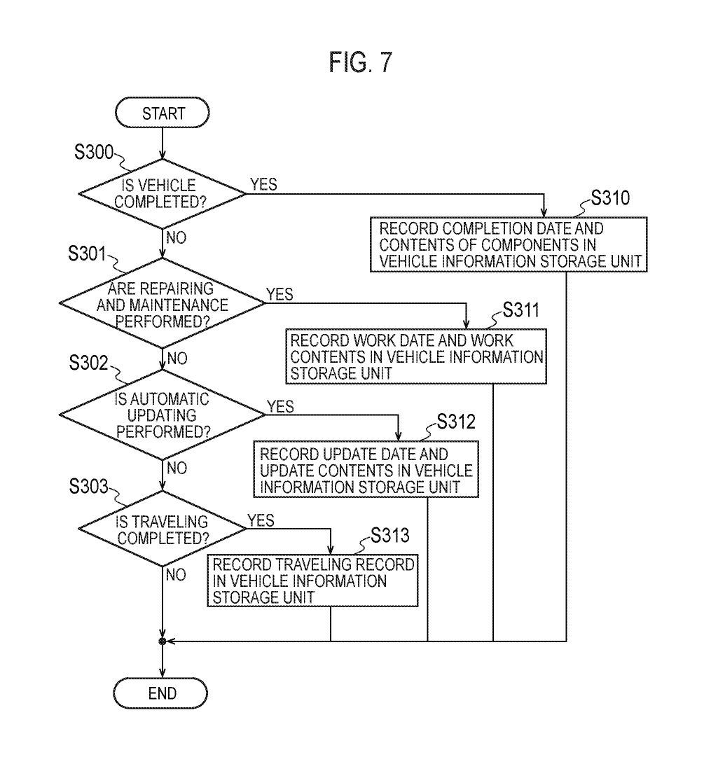

FIG. 7 illustrates an example of a flowchart of updating the vehicle information storage unit.

As illustrated in FIG. 7, if the vehicle is completed (step S300: Yes), a completion date, a type of the vehicle (vehicle 100), and components (hardware, software) of the vehicle in the vehicle information storage unit 113 is recorded (step S310). If repairing and maintenance are performed (step S301: Yes), the vehicle 100 records work contents such as work date of repairing and maintenance or replaced or added components (hardware, software) in the vehicle information storage unit 113 (step S311). If automatic updating of software or the like is performed (step S302: Yes), the vehicle 100 records the update contents such as a update date, a version of the software that has updated, and the like in the vehicle information storage unit 113 (step S312). Upon completion of the traveling (step S303: Yes), the vehicle (processing unit 103) records traveling records such as running time, traveling route, and the like in the vehicle information storage unit (step S313).

(Flow at the Time of Travel Request)

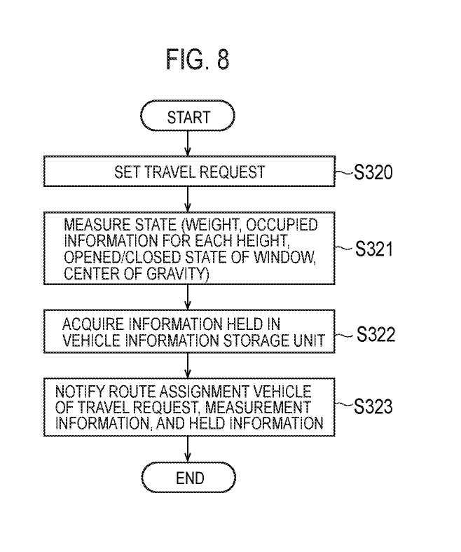

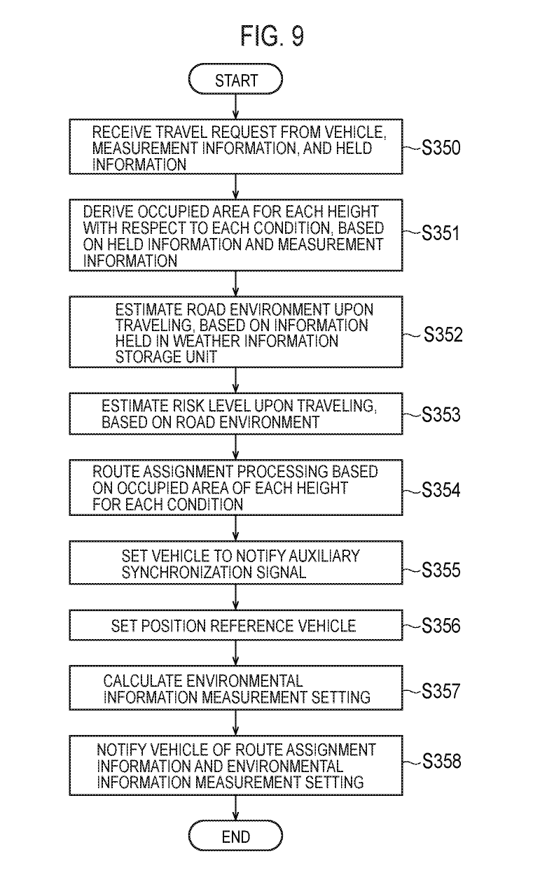

FIG. 8 is a diagram illustrating an example of a flowchart of the vehicle (vehicle 100) at the time of travel request. FIG. 9 is a diagram illustrating an example of a flowchart of the route assignment server at the time of travel request.

As illustrated in FIG. 8, in the vehicle 100, a passenger sets a travel request such as where he/she wants to go to and how to request a charge movement (step S320). The vehicle 100 measures the state of the vehicle such as the occupied area for each weight and height of the vehicle, the opening/closing state of the window, the center of gravity of the vehicle, and balance (step S321). The vehicle 100 reads vehicle information from the vehicle information storage unit 113 (step S322). The vehicle 100 notifies the route assignment server 200 of the travel request, the measurement information of the state of the vehicle, and the vehicle information held in the vehicle information storage unit 113 (step S323).

As illustrated in FIG. 9, the route assignment server 200 receives the travel request from the vehicle (vehicle 100), the measurement information of the state of the vehicle, and the vehicle information held in the vehicle information storage unit 113 (step S350). The route assignment server 200 calculates an occupied area for each height of the vehicle with respect to each of various road conditions, based on the vehicle information and the measurement information (step S351). The route assignment server 200 estimates a road environment after the present time based on the weather information and the environmental information held in the weather information storage unit 206 (step S352). The route assignment server 200 estimates the risk level of the road based on the estimated road environment (step S353). The route assignment server 200 performs route assignment processing based on the occupied area for each height of each vehicle, the estimated road environment, and the risk level for each of the various calculated road conditions (step S354). When necessary, the route assignment server 200 selects a vehicle to notify an auxiliary synchronization signal from the traveling vehicle, and notifies the auxiliary synchronization signal to the selected vehicle (step S355). In addition, when necessary, the route assignment server 200 selects a vehicle as the position reference of the other vehicle from among the traveling vehicles, and notifies the selected vehicle (step S356). The route assignment server 200 sets environmental information measurement (step S357). The route assignment server 200 notifies the vehicle of the route assignment information and the environmental information measurement setting (step S358).

(Occupied Area for Each Height)

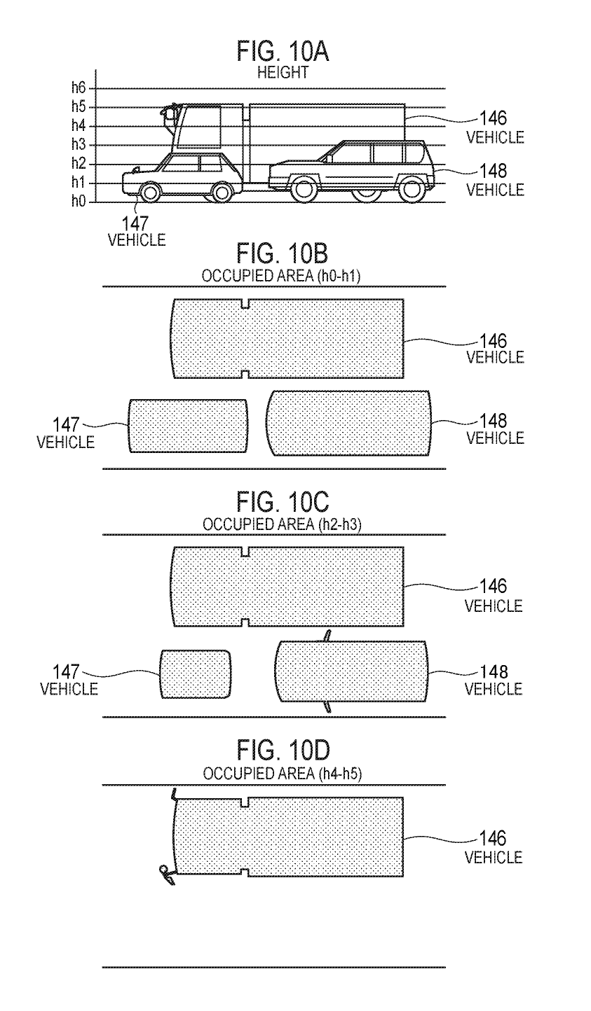

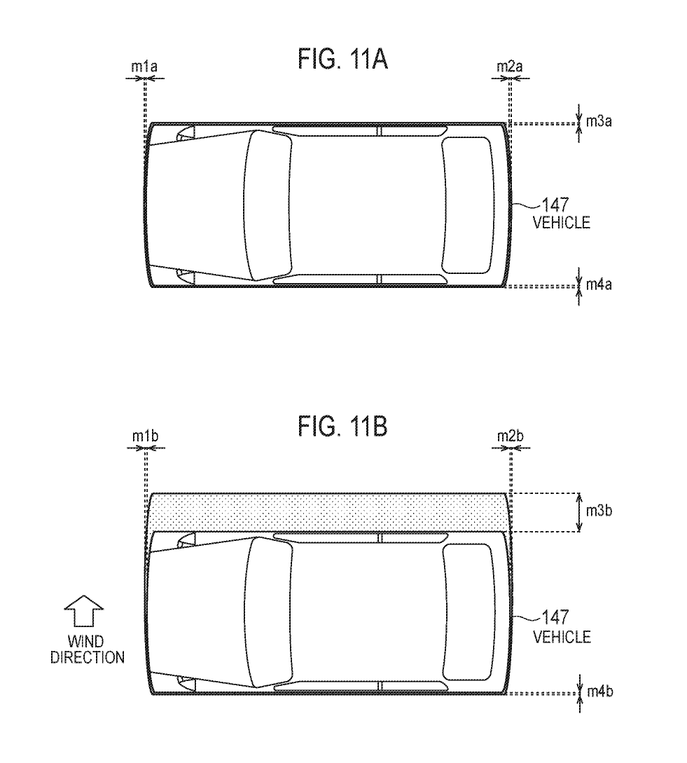

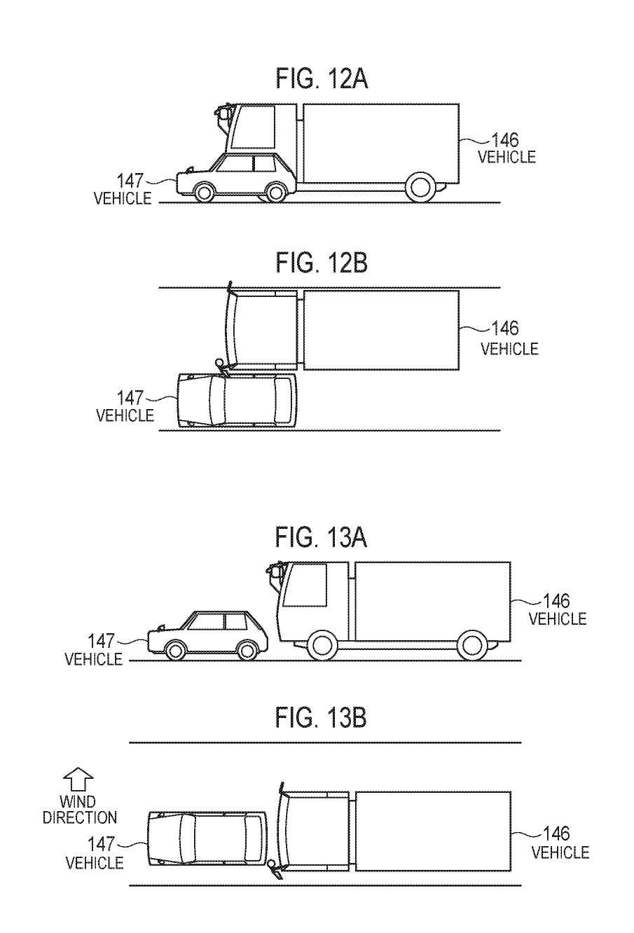

FIGS. 10A to 10D are diagrams illustrating road area occupied for each height (occupied area). FIGS. 11A to 11B are diagrams illustrating examples of setting of the occupied area by wind pressure. FIGS. 12A to 12B are diagrams illustrating road use in the case of no wind pressure. FIGS. 13A to 13B are diagrams illustrating road use in the case of wind pressure. The setting of the occupied area by the wind pressure in FIGS. 12A to 12B correspond to FIG. 11A. The setting of the occupied area by the wind pressure in FIGS. 13A to 13B correspond to FIG. 11B. The occupied area is indicated by shading (including the vehicle portion).

As illustrated in FIGS. 10A to 10D, FIG. 10A is a view (side view) of a vehicle when seen from the side. FIG. 10B, FIG. 10C, and FIG. 10D are views of a vehicle when viewed from the above. h0, h1, h2 . . . in FIG. 10A indicate the height from the road surface. FIG. 10B, FIG. 10C, and FIG. 10D illustrate part of the occupied area for each height. FIG. 10B illustrates the occupied area of each vehicle at height h0 to h1. FIG. 10C illustrates the occupied area of each vehicle at the height h2 to h3. FIG. 10D illustrates the occupied area of each vehicle at the height h4 to h5. A vehicle 147 and a vehicle 148 have a vehicle height lower than h4. Therefore, although the vehicle 147 and the vehicle 148 have occupied areas in FIG. 10B and FIG. 10C, there is no occupied area in FIG. 10D (h4 to h5). The vehicle 146 has a height of about h5. Therefore, the vehicle 146 has an occupied area in FIG. 10B, FIG. 10C, and FIG. 10D. The occupied area of the vehicle 148 has a substantially rectangular shape in FIG. 10B, but the occupied area in FIG. 10C has a shape in which a side mirror portion protrudes from the rectangular shape. The occupied area of the vehicle 146 has a substantially rectangular shape in FIG. 10B and FIG. 10C, but the occupied area in FIG. 10D has a shape in which the portion of the side mirror protrudes from the rectangular shape. In each of the vehicle 146 and the vehicle 148, it means that attention is paid to the protrusion of the side mirror portion at each height.

As illustrated in FIGS. 11A to 11B, FIG. 11A illustrates a case where there is no wind pressure and FIG. 11B illustrates a case where there is the wind pressure. The wind pressure is applied from the left side of the vehicle 147. In the case where there is no wind pressure (FIG. 11A), the occupied area of the vehicle 147 is occupied in the occupied area based on the size of the vehicle 147, and the occupied area is larger by the accuracy of travel control based on vehicle information. The parts based on the accuracy of the travel control are the front m1a, the rear m2a, the right m3a, and the left m4a. On the other hand, in the case where there is the wind pressure (FIG. 11B), the parts based on the accuracy of the travel control are the front m1b, the rear m2b, the right m3b, and the left m4b, and the right m3b is large.

As illustrated in FIGS. 12A to 12B, FIG. 12A is a side view and FIG. 12B is a top view. In the case where there is no wind pressure, the vehicle 146 and the vehicle 147 are traveling in parallel. It seems from the top view of FIG. 12B that the side mirror of the vehicle 146 overlaps the upper side of the vehicle 147 and the upper side of the road side, but it can be seen from the side view of FIG. 12A that the side mirror of the vehicle 146 does not overlap the vehicle 147. Therefore, the vehicle 146 and the vehicle 147 can travel in parallel with the vehicle. As a result, the route assignment server 200 instructs the vehicle 146 and the vehicle 147 to travel in parallel.

As illustrated in FIGS. 13A to 13B, FIG. 13A is a side view and FIG. 13B is a top view. The vehicle 146 and the vehicle 147 are traveling in cascade. As illustrated in FIG. 11B, the occupied area is required for m3b on the right side by the wind pressure. Therefore, if trying to travel in parallel as illustrated in FIG. 12B, there is a risk that the vehicle 147 flows rightward due to the wind pressure and comes into contact with the vehicle 146. In addition, similarly to the vehicle 147, there is a possibility that the vehicle 146 will also be blurred to the right due to the wind pressure. Therefore, as illustrated in FIG. 12B, if traveling in the vicinity of the right edge of the road, there is a risk of flowing to the right side by the wind pressure and contacting the road side strip. As a result, as illustrated in FIG. 13B, the wind pressure and the route assignment server 200 assume the influence in the vehicles 146 and 147 and instructs the traveling toward the left side of the road.

(Setting of Occupied Area by Taking into Account Aged Deterioration)

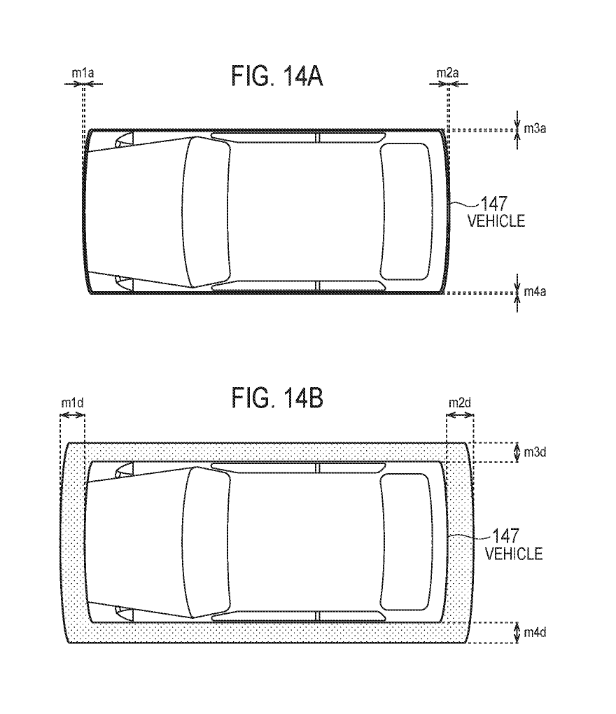

FIGS. 14A to 14B are diagrams illustrating examples of setting of the occupied area by aged deterioration. FIG. 14A is a diagram illustrating the occupied area at the time of completion. FIG. 14B is a diagram illustrating the occupied area after lapse of time after completion. The occupied area is indicated by shading (including the vehicle portion).

As illustrated in FIGS. 14A to 14B, since there is no abrasion or aged deterioration of the parts as components immediately after completion, the area occupied by abrasion and deterioration does not increase (FIG. 14A). On the other hand, with the lapse of use time, various components are worn and deteriorated, and the degree of abrasion and deterioration increases. Thus, the occupied area required for not contacting the surroundings becomes wider (FIG. 14B).

(Setting of Occupied Area by Taking into Account Road Surface Condition)

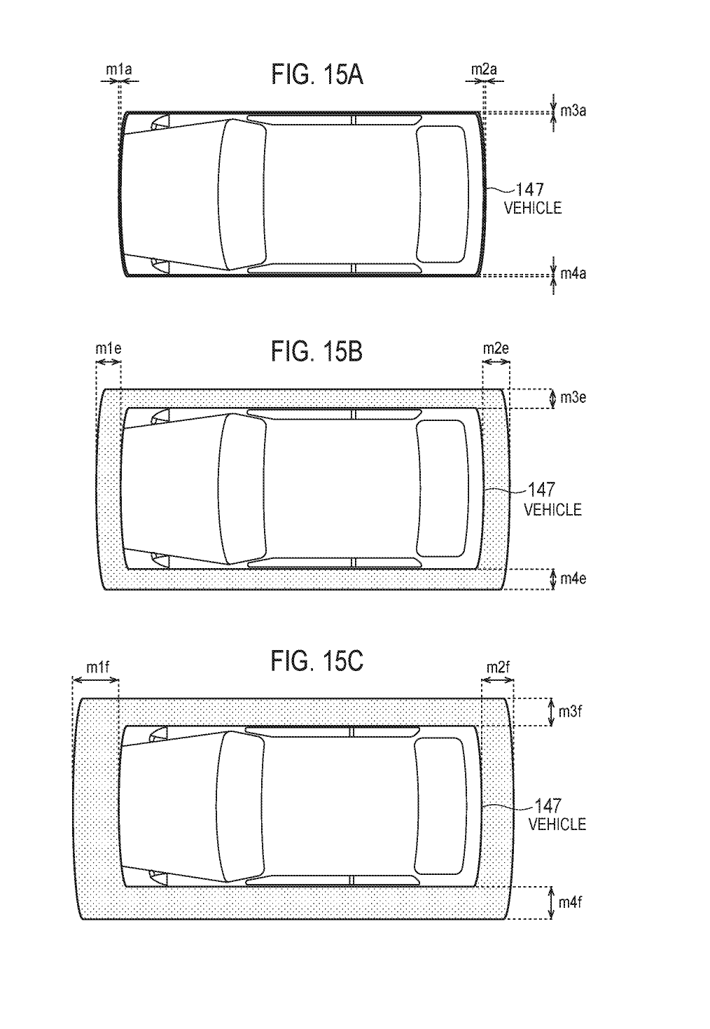

FIGS. 15A to 15C are diagrams illustrating examples of setting of the occupied area according to the road surface condition. FIG. 15A is a diagram illustrating the occupied area in a case where the road surface is dry. FIG. 15B is a diagram illustrating the occupied area if the road surface is flooded. FIG. 15C is a diagram illustrating the occupied area in a case where the road surface is snowy. The occupied area is indicated by shading (including the vehicle portion).

As illustrated in FIGS. 15A to 15C, if the road surface is dry, there is no influence on the traveling control and the occupied area does not increase (FIG. 15A). On the other hand, if flooded, the traveling control will be affected by the resistance of the flooded water. Therefore, the occupied area becomes wider (FIG. 15B). In addition, if snow is piled up, the snow also affects the traveling control. Therefore, the occupied area becomes wider (FIG. 15C).

(Flow Upon Vehicle Abnormality Detection)

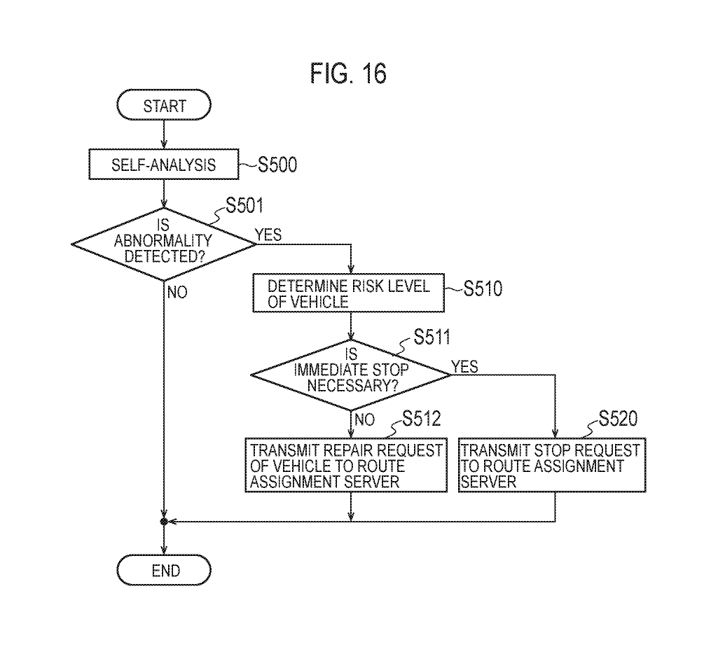

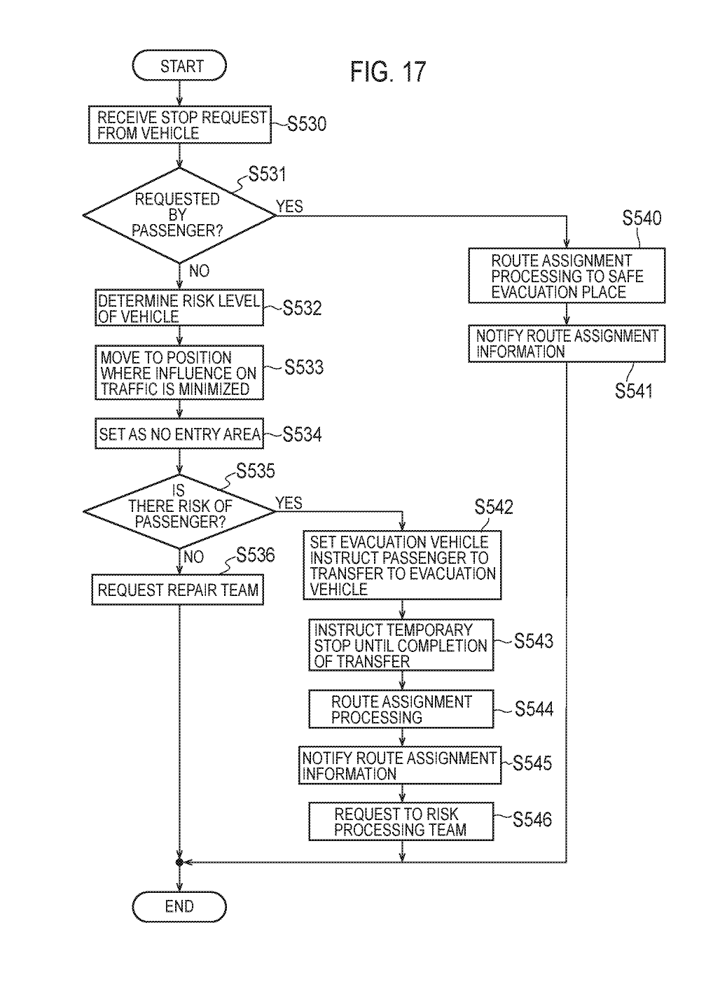

FIG. 16 is a flowchart of a vehicle upon abnormality detection. FIG. 17 is a flowchart of a route assignment server upon reception of a stop request.

As illustrated in FIG. 16, the vehicle 100 performs self-diagnosis of the vehicle (step S500). As a result of the self-diagnosis, if an abnormality is detected (step S501: Yes), the vehicle 100 determines a risk level due to the abnormality (step S510). As a result of the determination, if the vehicle determines that immediate stop is necessary (step S511: Yes), the vehicle 100 transmits a stop request to the route assignment server 200 (step S520). On the other hand, if the vehicle determines that immediate stop is not necessary (step S511: No), the vehicle 100 transmits a repair request of the vehicle 100 to the route assignment server 200 (step S512). If the repair request is received from the vehicle 100, the route assignment server 200 changes the destination of the vehicle 100 to a safety evacuation place and arranges for repair arrangement and/or arrangements for a substitute vehicle.

As illustrated in FIG. 17, the route assignment server 200 receives the stop request from the vehicle (step S530). Based on the received stop request, the route assignment server 200 checks whether the stop request is a request from the passenger (step S531). If the stop request is a request from the passenger (step S531: Yes), the route assignment server 200 performs route assignment processing to a safety evacuation place where the passenger can safely get off (step S540). The route assignment server 200 generates and notifies route assignment information (step S541). If the received stop request is not a request from the passenger (step S531: No), the route assignment server 200 determines a risk level of the vehicle from the received stop request (step S532) and instructs the movement of the vehicle to a position where the influence on the traffic is minimized (step S533). The route assignment server 200 sets a no entry area according to the risk of the vehicle (step S534). If it is determined that there is a risk of the passenger (step S534: Yes), the route assignment server 200 selects an evacuation vehicle from among nearby traveling vehicles and instructs the passenger to transfer to the evacuation vehicle (step S542). The route assignment server 200 instructs a temporary stop for all vehicles in a period until completion of transfer (step S543), the route assignment server 200 performs route assignment processing (step S544), and generates and notifies route assignment information (Step S545). The route assignment server 200 requests processing to a processing team (processing company) capable of coping with the generated risk for the processing of the stopped vehicle (step S546). If it is determined that there is no risk of the passenger (step S535: No), the route assignment server 200 requests a repair team (repairer) to perform processing for repairing the stopped vehicle (step S536).

Therefore, if the vehicle stop request is generated, it is possible to minimize the influence on the traffic of the stopped vehicle. As the stop request from the passenger, for example, there is a case where the passenger instructs the vehicle to stop or get off the vehicle without designating a destination, a case where an operation of opening a door is performed, a case where there is a hindrance to traveling, such as a window or a sunroof, to some extent. As a vehicle stop request of the vehicle itself is, for example, there is a stop due to an engine trouble or a brake damage. As the risk of the passenger, for example, that there is a case where there is a risk of fire, a case where there is a risk of toxic gas generation, and a case where it is determined that there is a risk that the waiting in the stopped vehicle may harm the passenger's life due to weather conditions such as scorching sun or freezing. For example, if there is no risk such as fire of the vehicle itself, the position of the stopped vehicle is treated as a no entry area. If there is a risk such as fire of the vehicle itself, the influence range assumed by the fire is set as the no entry area. The selection of the evacuation vehicle, for example, allows a user to immediately move to a changeable position and selects a vehicle having a vacant seat for passengers getting off. If there is no vehicle in which all passengers can get in with one vehicle in nearby vehicles, a plurality of vehicles are set as evacuation vehicles. Therefore, it is possible to promptly evacuate all the passengers without increasing the number of vehicles that passengers can get off unnecessarily.

(Flow of Detection of Abnormal Vehicle)

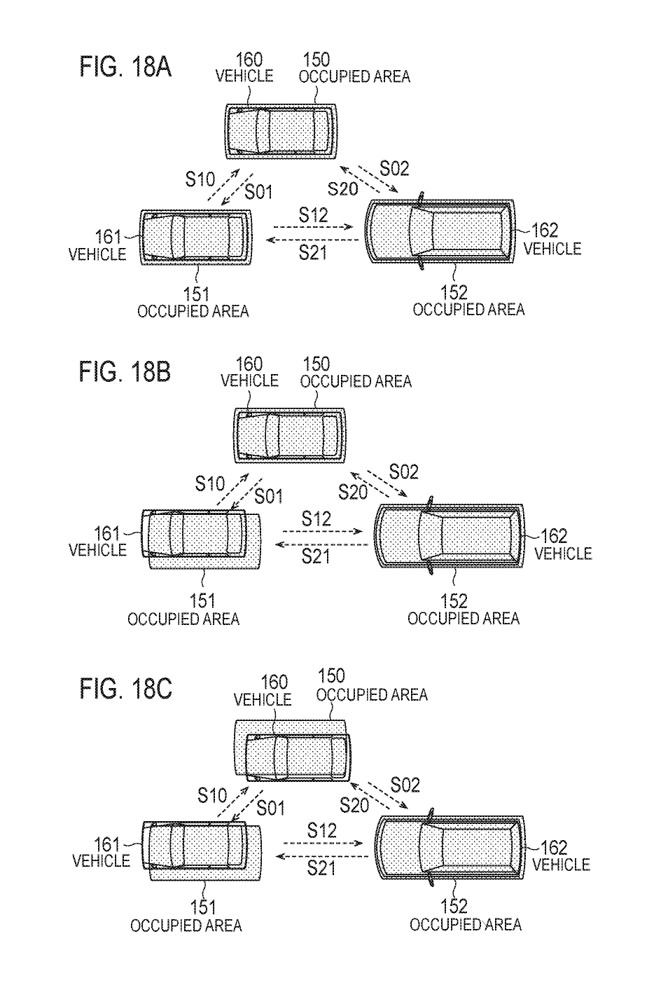

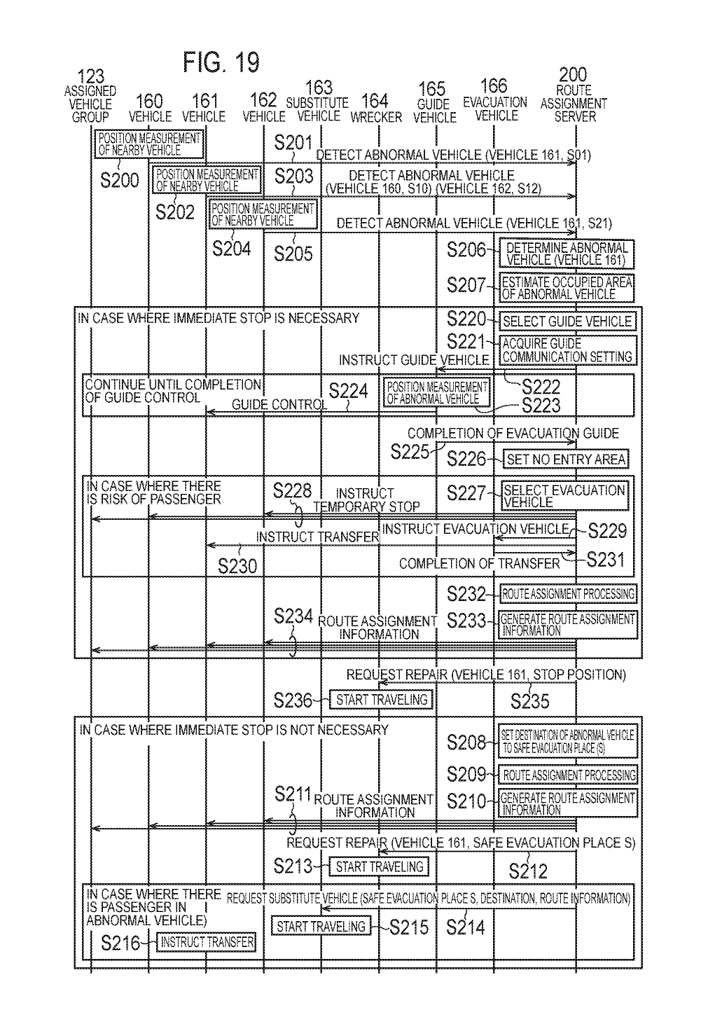

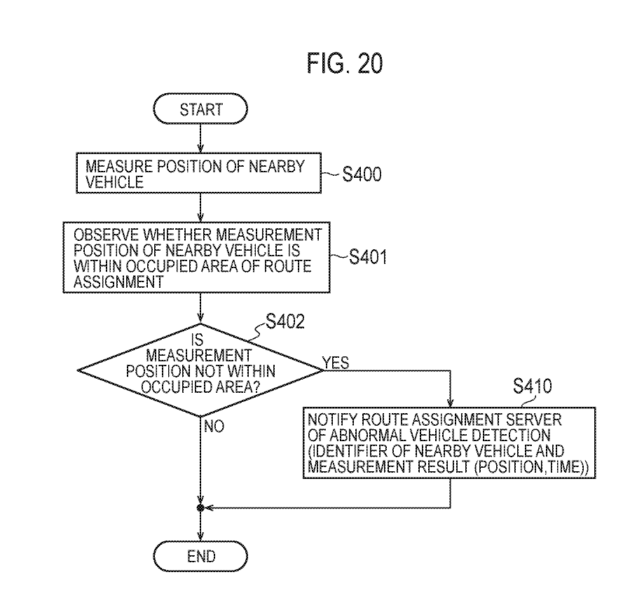

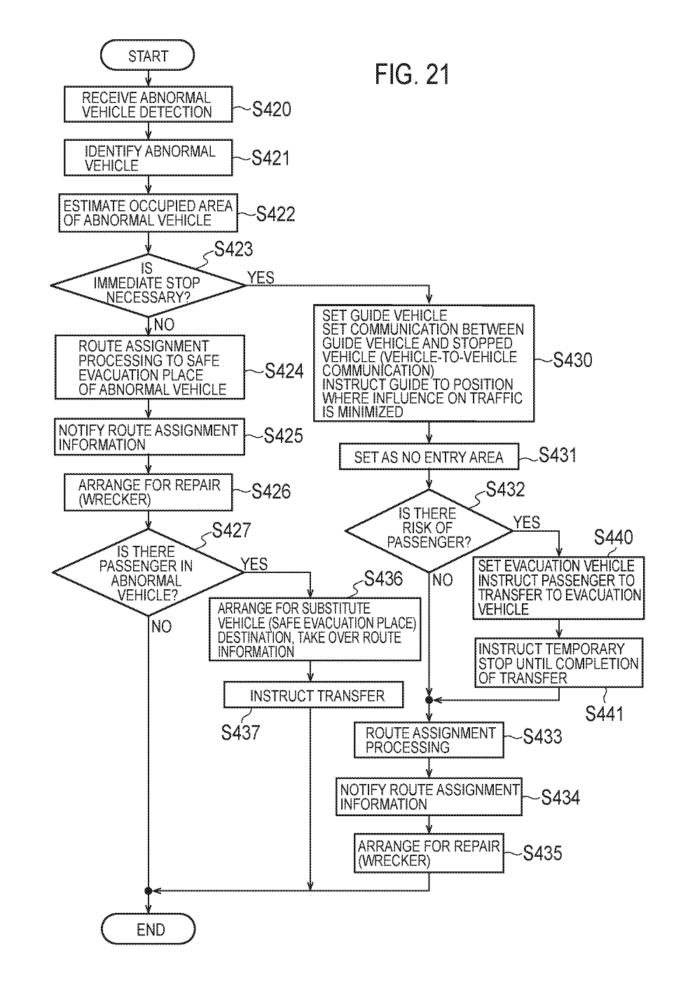

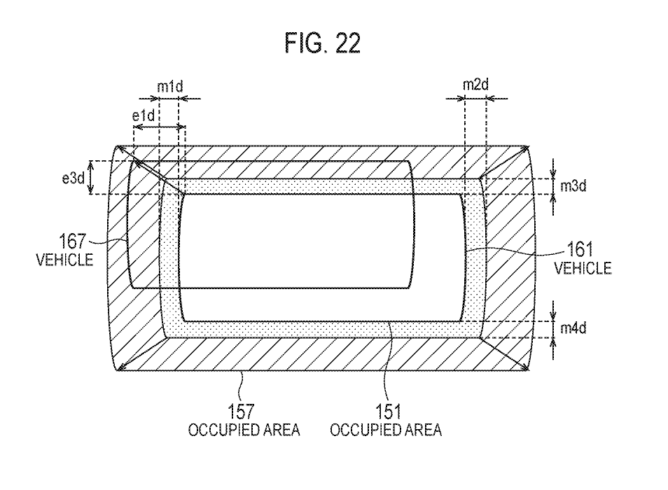

FIGS. 18A to 18C are diagrams illustrating detection of an abnormal vehicle. FIG. 18A illustrates a case where all the vehicles are normal. FIG. 18B illustrates a case where one vehicle is an abnormal vehicle. FIG. 18C illustrates a case where two vehicles are abnormal vehicles. The shaded area indicates an occupied area. FIG. 19 is a diagram illustrating an example of a flow of abnormal vehicle detection. FIG. 20 is a flowchart of the vehicle upon position measurement of the nearby vehicle. FIG. 21 is a flowchart of the route assignment server upon reception of an abnormal vehicle notification. FIG. 22 is a diagram illustrating an example of a setting of an occupied area of an abnormal vehicle.

As illustrated in FIGS. 18A to 18C, at a certain time, the route assignment server 200 assigns an occupied area 150, an occupied area 151, and an occupied area 152 to a vehicle 160, a vehicle 161, and a vehicle 162, respectively. The vehicle 160 measures the positions of the nearby vehicles 161 and 162 and acquires measured values S01 and S02, respectively. Similarly, the vehicle 161 measures the positions of the vehicle 160 and the vehicle 162, which are the nearby vehicles, and acquires measured values S10 and S12, respectively. Similarly, the vehicle 162 measures the positions of the vehicle 160 and the vehicle 161, which are the nearby vehicles, and acquires measured values S20 and S21, respectively.

As illustrated in FIG. 18A, if the vehicle 160, the vehicle 161, and the vehicle 162 are normal vehicles, it is determined from the measurement values that the vehicle 160, the vehicle 161, and the vehicle 162 are within the occupied area 150, the occupied area 151, and the occupied area 152. From these results, the route assignment server 200 determines that there is a high possibility that the vehicle will not be an abnormal vehicle.

As illustrated in FIG. 18B, if the vehicle 161 is an abnormal vehicle, the vehicle 160 determines that the vehicle 161 is not within the occupied area 151, based on the measurement value S01. Based on the measurement value S21, the vehicle 162 determines that the vehicle 161 is not within the occupied area 151. On the other hand, the vehicle 161 determines that the vehicle 160 is not within the occupied area 150 and that the vehicle 162 is not within the occupied area 152, based on the measurement value S10. From these results, the route assignment server 200 determines that there is a high possibility that the vehicle 161 will be an abnormal vehicle.

As illustrated in FIG. 18C, if the vehicle 160 and the vehicle 161 are abnormal vehicles, the vehicle 160 determines that the vehicle 161 is not within the occupied area 151, based on the measurement value S01, and the vehicle 162 is not within the occupied area 52, based on the measurement value S02. Based on the measurement value S10, the vehicle 161 determines that the vehicle 160 is not within the occupied area 150. Based on the measurement value S12, it is determined that the vehicle 162 is not within the occupied area 152. Similarly, based on the measurement value S20, the vehicle 162 determines that the vehicle 160 is not within the occupied area 150. Based on the measurement value S21, it is determined that the vehicle 161 is not within the occupied area 151. From this result, the route assignment server 200 determines that there is a high possibility that all of the vehicles will be abnormal vehicles.

In addition, as illustrated in FIG. 18A, in a state in which the vehicle 160, the vehicle 161, and the vehicle 162 are respectively within the occupied area 150, the occupied area 151, and the occupied area 152, if there is an error in the measurement means of the vehicle 160, the vehicle 160 determines that the vehicle 161 is not within the occupied area 151, based on the measurement value S01. Based on the measurement value S02, it is determined that the vehicle 162 is not within the occupied area 152. From the determination that the vehicle 161 and the vehicle 162 are within the occupied areas for each position, the route assignment server 200 determines that there is a high possibility that the vehicle 160 will be an abnormal vehicle.

The route assignment server 200 determines a possibility of an abnormal vehicle based on the determination as to whether nearby vehicles are within each occupied area. Therefore, it is possible to detect an abnormal vehicle even if the abnormality of the vehicle self-confidence cannot be detected by self-determination.

In FIG. 19, an example in a case where the vehicle 161 is an abnormal vehicle (see FIG. 18B) is illustrated. The vehicle 160 performs the position measurement of the nearby vehicle (step S200). As a result of the measurement, the vehicle 160 determines that the vehicle 161 is not within the occupied area 151, and notifies the route assignment server 200 of the abnormal vehicle notification (the vehicle 161, the measured value S01) (step S201).

The vehicle 161 performs the position measurement of the nearby vehicle (step S202). As a result of the measurement, the vehicle 161 determines that the vehicle 160 is not within the occupied area 150 and the vehicle 162 is not within the occupied area 152, and notifies the route assignment server 200 of the abnormal vehicle notification (the vehicle 160, the measured value S10) and (the vehicle 162, the measured value S12) (step S203).

The vehicle 162 performs the position measurement of the nearby vehicle (step S204). As a result of the measurement, the vehicle 162 determines that the vehicle 161 is not within the occupied area 151, and notifies the route assignment server 200 of the abnormal vehicle notification (the vehicle 161, the measured value S21) (step S205).

The route assignment server 200 performs abnormal vehicle determination and determines that there is a high possibility that the vehicle 161 will be an abnormal vehicle (step S206). The route assignment server 200 estimates the occupied area of the abnormal vehicle based on the measurement value of the abnormal vehicle detection (step S207).

As a result of performing the estimation of the occupied area of the abnormal vehicle, if it is determined that continuing the traveling has a risk of greatly impairing traffic, that is, if it is determined that immediate stop is necessary, the route assignment server 200 selects the guide vehicle 165 from the nearby traveling vehicle (step S220). The route assignment server 200 acquires a setting of a communication means between the guide vehicle and the abnormal vehicle. For example, if resource management of vehicle-to-vehicle communication is under the control of a base station of radio communication, the acquisition is requested from the base station. The guide vehicle instruction is issued to the guide vehicle 165 (step S222). The guide vehicle instruction includes a vehicle to be guided, a guide destination, a communication method used for guiding, and the like. While the guide vehicle 165 measures the position of the abnormal vehicle 161 (step S223), the abnormal vehicle is guided and controlled to the position of the guide destination (step S224). For example, it means that the guide vehicle 165 remotely performs the driving control operation of the abnormal vehicle 161 up to the target position, based on the position measurement of the abnormal vehicle 161 of the guide vehicle 165, instead of the abnormal vehicle 161. Alternatively, the position measurement value of the abnormal vehicle 161 of the guide vehicle 165 is notified to the abnormal vehicle 161, and the abnormal vehicle 161 drives and controls the target position based on the position measurement value of the guide vehicle 165. Therefore, low delay is desirable for the vehicle-to-vehicle communication between the guide vehicle 165 and the abnormal vehicle 161, and it is desirable that the communication resources are exclusively assigned while performing the guide operation. Upon completion of the guide, the guide vehicle 165 notifies the route assignment server 200 of the evacuation guide completion (step S225). The route assignment server 200 checks the evacuation state and sets the evacuation position to the no entry area (step S226).

If there is a risk of the passenger, the route assignment server 200 selects the evacuation vehicle 166 from the nearby traveling vehicle (step S227), instructs temporary stop to all vehicles (step S228), and issues an evacuation vehicle instruction to the evacuation vehicle 166 (step S229). The route assignment server 200 instructs the passenger of the abnormal vehicle to transfer (step S230). When the passenger completes the transfer from the abnormal vehicle 161, the evacuation vehicle 166 notifies the route assignment server 200 of the completion of transfer (step S231). The completion of the transfer is notified based on the passenger's declaration and the confirmation of the weight movement of the passenger in the abnormal vehicle 161 and the evacuation vehicle 166. The route assignment server 200 performs route assignment processing (step S232) and generates route assignment information (step S233). The route assignment server 200 notifies route assignment information to vehicles that need to update route assignment information (step S234). The route assignment server 200 requests the repair of the abnormal vehicle 161 (step S235). The repair request includes an identifier of the abnormal vehicle and a stop position of the abnormal vehicle. Based on the repair request, a wrecker 164 starts traveling toward the stop position of the abnormal vehicle 161 (step S236). The evacuation vehicle 166 sets a route that passes through a safety evacuation place so as to transfer passengers of the abnormal vehicle 161 to the substitute vehicle 163 at the safety evacuation place. If the passenger is waiting in the abnormal vehicle 161, the passenger is carried to the safety evacuation place by the wrecker 164 and transferred to the substitute vehicle 163.

If it is determined that immediate stop is unnecessary, the route assignment server 200 sets the destination of the abnormal vehicle 161 to the safety evacuation place (S) (step S208). The route assignment server 200 performs route assignment processing (step S209) and generates route assignment information (step S210). The route assignment server 200 notifies the route assignment information to vehicles that need to update the route assignment information (step S211). As the occupied area of the abnormal vehicle 161 is changed and the destination (safety evacuation place (S)) is changed, the route assignment information is updated in the vehicle traveling on the relevant road. The route assignment server 200 requests the wrecker 164 to repair the vehicle 161 and instructs the safety evacuation place (S) as the place secured by the vehicle 161 (step S212). The wrecker 164 starts moving to the safety evacuation place (S) (step S213). If there is a passenger on the abnormal vehicle 161, the route assignment server 200 issues a substitute vehicle request to the substitute vehicle 163. The route assignment server 200 instructs the safety evacuation place (S) as a transfer place and notifies the destination of the vehicle 161 and the route information after the transfer (step S214). The substitute vehicle 163 starts moving to the safety evacuation place (S) (step S215). The abnormal vehicle 161 outputs a transfer instruction to the passenger (step S216).

As illustrated in FIG. 20, the vehicle 100 measures the position of the nearby vehicle (step S400), and whether the measurement position of the nearby vehicle is within the occupied area of the route assignment is observed (step S401). If the measurement position is not within the occupied area (step S402: Yes), the vehicle 100 notifies the route assignment server 200 of the identifier of the nearby vehicle and the measurement result (position, time) (step S410).

As illustrated in FIG. 21, if the route assignment server 200 receives the abnormal vehicle detection (step S420), the route assignment server 200 identifies the abnormal vehicle based on the received abnormal vehicle detection (step S421). The route assignment server 200 estimates the occupied area of the abnormal vehicle (step S422). The route assignment server 200 determines whether it is necessary to immediately stop the abnormal vehicle. If the route assignment server 200 determines that it is necessary to immediately stop the abnormal device (step S423: Yes), the route assignment server 200 selects a guide vehicle from among the nearby traveling vehicles, performs a communication setting between the guide vehicle and the abnormal vehicle, and instructs the guide vehicle to guide to a position where the influence on traffic is minimized (step S430). The determination that immediate stop is needed is, for example, a case where it is determined that the estimated occupied area of the abnormal vehicle is widened and it is impossible to travel without contacting the road. The route assignment server 200 sets the position of the abnormal vehicle, for which the guide has been completed, to the no entry area (step S431). If it is determined that the passenger of the abnormal vehicle is in danger (step S432: Yes), the route assignment server 200 selects the evacuation vehicle from among the nearby traveling vehicles and instructs the passenger of the abnormal vehicle to transfer to the evacuation vehicle (step S440). During the passenger's transfer period, the route assignment server 200 instructs all vehicles to stop (step S441). The route assignment server 200 performs route assignment processing (step S433). The route assignment information is notified to the vehicles that need updating (step S434). The route assignment server 200 performs repair arrangement of the abnormal vehicle (step S435).

If it is determined that immediate stop is not needed (step S423: No), the route assignment server 200 performs route assignment processing to the safety evacuation place of the abnormal vehicle (step S424). The route assignment server 200 generates route assignment information and notifies the route assignment information to vehicles that need to update the route assignment information (step S425). The route assignment server 200 performs repair arrangement of the abnormal vehicle (step S426). If there is a passenger on the abnormal vehicle (step S427: Yes), the route assignment server 200 arranges for a substitute vehicle (step S436). The route assignment server 200 instructs the substitute vehicle to move to the safety evacuation place where the abnormal vehicle is going to move. In addition, the route assignment server 200 hands over the original destination and the route information of the abnormal vehicle to the substitute vehicle. The route assignment server 200 notifies the passenger of the abnormal vehicle to transfer to the substitute vehicle (step S437).

The state of the vehicle 161 in FIG. 18B will be described with reference to FIG. 22. The traveling direction of the vehicle is on the left side of the drawing. Before the vehicle 161 is determined as an abnormal vehicle, it is assumed that the occupied area 151 is set as the occupied area of the vehicle 161 by the route assignment server 200. The measurement position of the vehicle 161 received by the route assignment server 200 in the abnormal vehicle detection from the vehicle 160 and the vehicle 162 traveling in the vicinity is set as the vehicle 167. The vehicle 161 does not fit within the occupied area 151 but is shifted to the position of the vehicle 167. The amount of deviation from the position of the vehicle 161 is (e1d, e3d). As a result, the area occupied by the vehicle 167 is at least m1d+e1d forward, m2d+e1d rearward, m3d+e3d to the right, and m4d+e3d to the left with respect to the basic position (vehicle 161), and the occupied area 157, which is a hatched area, is regarded as an occupied area after it is detected as an abnormal vehicle. Therefore, the route assignment server 200 performs calculation in the route assignment processing up to the safety evacuation place (S) by using the occupied area 157. When the route assignment server 200 notifies the vehicle 161 of the route assignment information up to the safety evacuation place (S), the route assignment server 200 notifies the route assignment information of the previous occupied area 151 as it is.

(Flow of Parked/Stopped Vehicle)

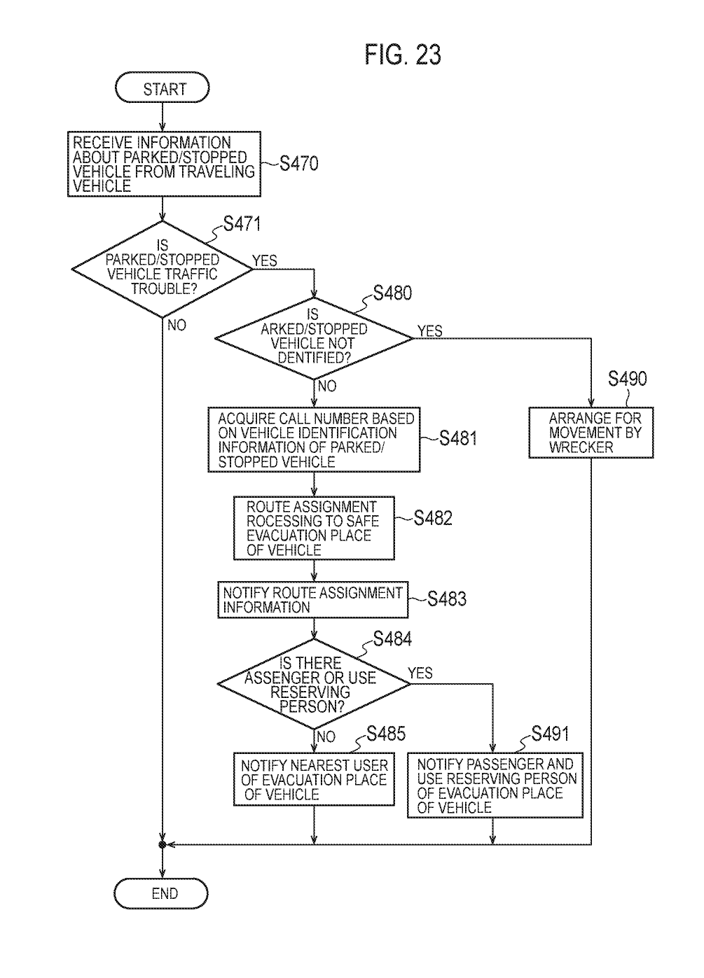

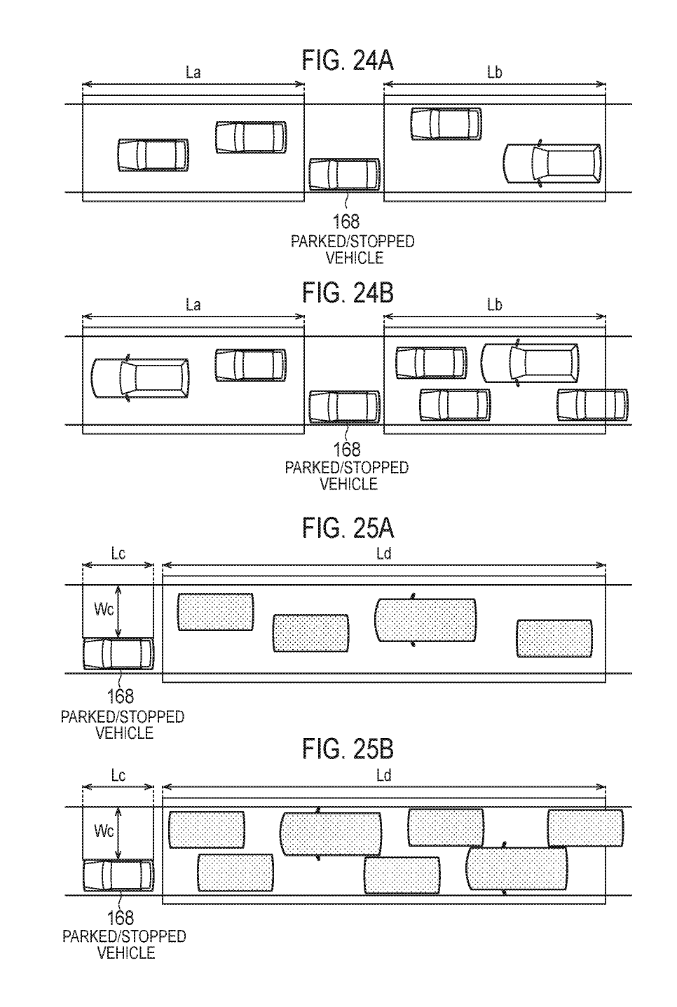

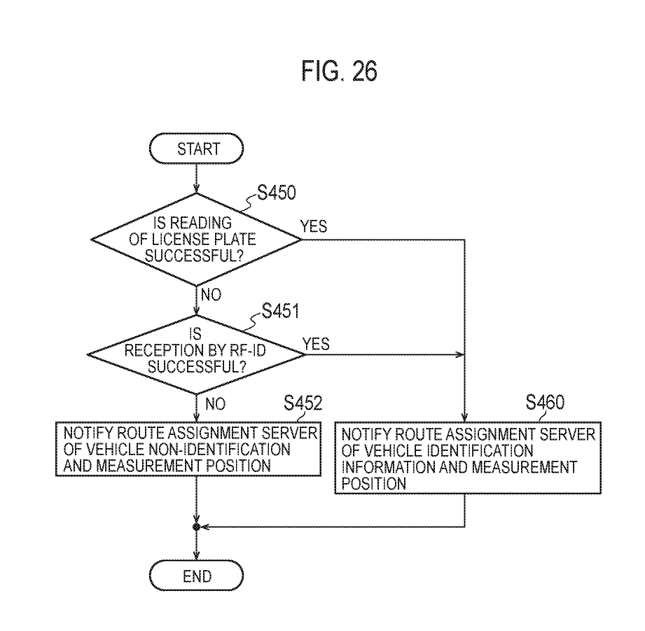

FIG. 23 is a flowchart of a route assignment server with respect to a parked/stopped vehicle. FIG. 24 is a diagram illustrating determination of a traffic trouble of a parked/stopped vehicle. FIG. 25 is a diagram illustrating determination of a traffic trouble of a parked/stopped vehicle. FIG. 26 is a flowchart of a vehicle in acquiring vehicle identification information.

As illustrated in FIG. 23, the route assignment server 200 receives information about parked/stopped vehicles from the traveling vehicle (step S470). The received information include the position and time of the parked/stopped vehicle, the presence or absence of the vehicle identification information identifying the parked/stopped vehicle, and the like. The vehicle identification information is, for example, a license plate. The route assignment server 200 determines whether the parked/stopped vehicle is a traffic trouble and whether the parked/stopped vehicle becomes an obstacle in the near future based on the information about the parked/stopped vehicle (step S471). In the route assignment server 200, vehicles of which processing has already been determined by abnormal vehicle determination or the like are excluded from subjects to be determined.

If it is determined as a traffic trouble (step S471: Yes), the route assignment server 200 confirms the presence or absence of the vehicle identification information of the parked/stopped vehicle, and if the vehicle cannot be identified (step S480: Yes), the wrecker performs a movement arrangement for forced evacuation of parked/stopped vehicles (step S490). If the parked/stopped vehicle can be identified (step S480: No), the route assignment server 200 acquires a call number or an address for accessing the parked/stopped vehicle based on the vehicle identification information (step S481). The route assignment server 200 performs route assignment processing to the vehicle safety evacuation place (step S482), generates route assignment information, and notifies the route assignment information (step S483). The route assignment server 200 notifies the parked/stopped vehicle of the route assignment information to the safety evacuation place by using the call number or the address, and instructs the route assignment information to be executed. At the same time, if there is a passenger or a use reserving person in the parked/stopped vehicle (step S484: Yes), the route assignment server 200 notifies the passenger or the reserving person of the vehicle evacuation and evacuation place (step S491). If there is no passenger or use reserving person in the parked/stopped vehicle (step S484: No), the route assignment server 200 notifies the nearest user of the vehicle evacuation and evacuation place (step S485).

As illustrated in FIGS. 24A to 24B, the number of vehicles in a road section La before the parked/stopped vehicle 168 is compared with the number of vehicles in a road section Lb after the parked/stopped vehicle 168. A time average value of the number of vehicles in the road section La is set as N(La) and a time average value of the number of vehicles in the road section Lb is set as N(Lb). As illustrated in FIG. 24A, if the parked/stopped vehicle 168 is not in a traffic trouble, it can be said that there is no difference in the time-average number of vehicles before and after the parked/stopped vehicle 168 (N(La)=N(Lb)). As illustrated in FIG. 24B, if the parked/stopped vehicle 168 is in a traffic trouble, since the vehicle delay after the parked/stopped vehicle 168 occurs, the time-average number of vehicles in the road section Lb after the parked/stopped vehicle becomes larger than that in the road section La before the parked/stopped vehicle 168 ((N(La)<N(Lb)). Therefore, by looking at N(La) and N(Lb), it is possible to determine whether the parked/stopped vehicle 168 is a traffic trouble. Since the route assignment server 200 has the route assignment information of the vehicle, it can be verified in the near future.

As illustrated in FIGS. 25A to 25B, a vehicle length of the parked/stopped vehicle 168 is set as Lc and a width of the road narrowed by the parked/stopped vehicle 168 is set as Wc. In a road section Ld after the parked/stopped vehicle 168, the occupied area of the traveling vehicle is indicated by shading. In the road section Ld, the total sum of occupied areas of the traveling vehicle is set as S. If the width of the average occupied area of the vehicle traveling on the road section Ld is sufficiently smaller than the road width Wc (S/Ld×Lc<Wc), it can be said that there is a high possibility that the parked/stopped vehicle 168 will not become a traffic trouble (FIG. 25A). On the other hand, if the width of the average occupied area of the vehicle traveling in the road section Ld is larger than the road width Wc (S/Ld×Lc>Wc), it can be said that the parked/stopped vehicle 168 will become a traffic trouble (FIG. 25 B). The route assignment server 200 has route assignment information of the vehicle. Since the state changes to a state illustrated in FIG. 25B when a traffic trouble occurs, it is possible to determine whether the parked/stopped vehicle 168 becomes a traffic trouble by watching the previous situation.

As illustrated in FIG. 26, if the vehicle (vehicle 100) images the license plate of a nearby vehicle with a camera and succeeds in character recognition (step S450: Yes), the vehicle sets the read character string as the vehicle identification information and notifies the route assignment server 200 of the vehicle identification information together with the position of the vehicle (step S450). In a case where the character recognition fails (step S450: No), if the vehicle that reads the vehicle identification information from an RF-ID arranged in the nearby vehicle by an RF-ID reading device succeeds in receiving the vehicle identification information (step S451: Yes), the vehicle uses the read character string as the vehicle identification information and notifies the route assignment server 200 of the vehicle identification information together with the position of the vehicle (step S460). If the reading of the RF-ID fails (step S451: No), the vehicle notifies the route assignment server 200 of the vehicle position as vehicle non-identification (step 452). Alternatively, a method of acquiring vehicle identification information of a nearby vehicle by using vehicle-to-vehicle communication may be used. In this case, a vehicle identification information request including the position of the vehicle and its measurement time thereof is notified to the nearby vehicle. The nearby vehicle that has received the request performs comparison with the position of the vehicle at the measurement time, and if it is determined as being matched or approximated, that is, if it is determined that the vehicle inquires of the vehicle, the vehicle identification information including the position of the vehicle and the measurement time thereof is notified. As the failure of the character recognition, for example, there are a case of an obstacle such as contamination on a license plate, a case where it is impossible to read the license plate since it is too bright or too dark, a case where it is not in a positional relationship where the number plate can be imaged, or the like. In this case, the RF-ID is assumed to be a passive type RF-ID, but it may be an active type RF-ID.

(Flow of Route Assignment Information Notification)

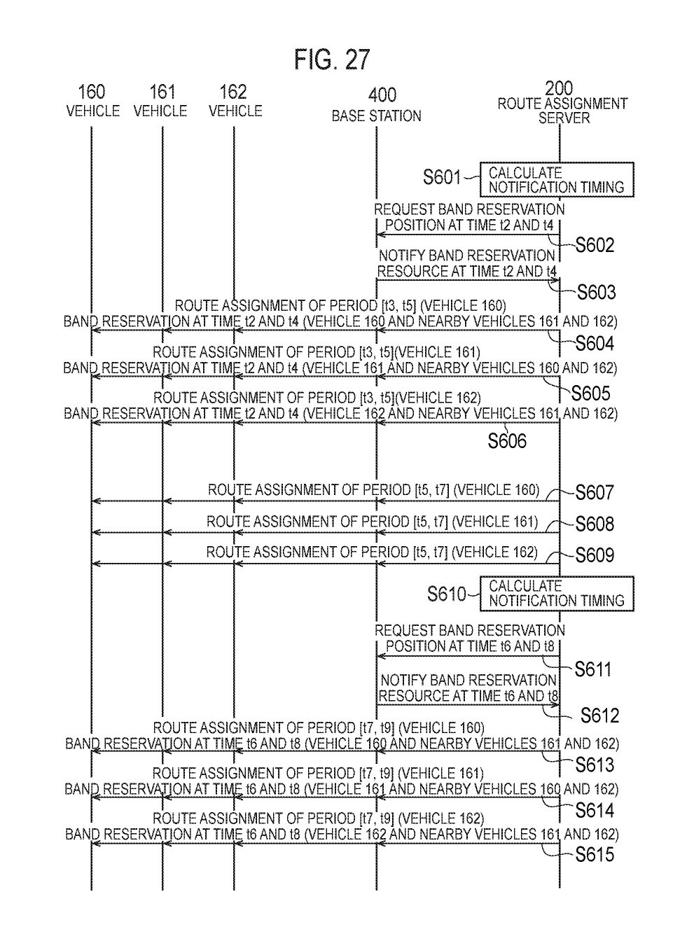

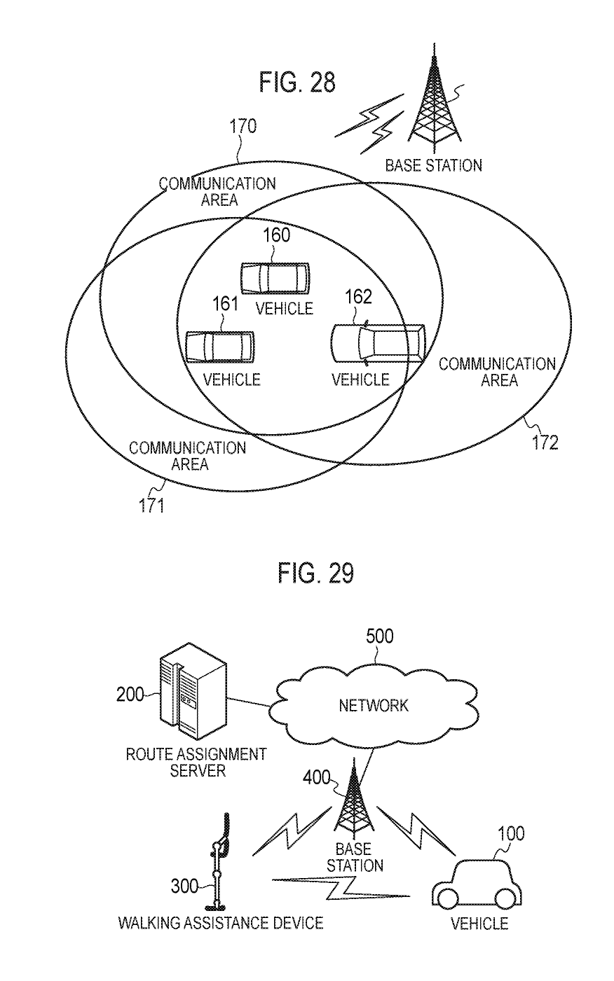

FIG. 27 is a diagram illustrating transmission of route assignment information. FIG. 28 is a diagram illustrating acquisition of notification information of a nearby vehicle.

As illustrated in FIG. 27, the route assignment (step S604, step S605, step S607) is transmission at time t0. The route assignment (step S607, step S608, step S609) is transmission at time t2. The route assignment (step S613, step S614, step S615) is transmission at time t4. The vehicle 160, the vehicle 161, and the vehicle 162 each travel in the vicinity. The route assignment server 200 obtains the traveling positions (road areas) of the vehicle 160, the vehicle 161, and the vehicle 162 at times t2 and t4 (step S601). The route assignment server 200 identifies a base station 400 that provides a service, based on the positions of the vehicle 160, the vehicle 161, and the vehicle 162 at time t2 and time t4. The route assignment server 200 performs a band (that is, radio resource) assignment request to the base station 400 (step S602). At this time, the data capacity required at the same time may be notified individually. The base station 400 performs band assignment in response to the band assignment request, and notifies the route assignment server 200 of the band reserved for each band (step S603). The route assignment server 200 transmits transmission data for the vehicle 160, the vehicle 161, and the vehicle 162 to the base station 400 so as to be in time for transmission at time t0 that is reserved in advance. The base station 400 transmits the transmission data in each pre-reserved band. At time t0, the route assignment information of the period [t3, t5] of the target vehicle, the target vehicle at times t2 and t4, and the reserved resources of the nearby vehicle are notified (step S604, step S605, step S606). Next, at time t2, the route assignment information of the period [t5, t7] of the target vehicle is notified (step S607, step S608, step S609). The route assignment server 200 obtains the traveling positions (road areas) of the vehicle 160, the vehicle 161, and the vehicle 162 at times t7 and t9 (step S610). In order to make a reservation of the transmission band at times t6 and t8 to be notified at time t4, the route assignment server 200 identifies the base station 400 that provides the service, based on the positions of the vehicle 160, the vehicle 161, and the vehicle 162 at time t6 and time t8, and perform a band assignment request to the base station 400 (step S611). The base station 400 performs band assignment in response to the request and notifies the route assignment server 200 of the band reserved for each band (step S612). The route assignment server 200 transmits transmission data for the vehicle 160, the vehicle 161, and the vehicle 162 to the base station 400 so as to be in time for transmission at time t4 that is reserved in advance. The base station 400 transmits the transmission data in each pre-reserved band. At time t4, the route assignment information of the periods [t7, t9] of the target vehicle, the target vehicle at times t6 and t8, and the reserved resources of the nearby vehicle are notified (step S613, step S614, step S615). Here, as the transmission resource at time t2, a frequency band f1 for the vehicle 160, a frequency band f2 for the vehicle 161, and a frequency band f3 for the vehicle 162 are notified. The vehicle 160 having received the route assignment notification (step S604) acquires the route assignment information for the vehicle 160 by receiving the frequency band f1 at time t2. By receiving the frequency band f2, the vehicle 161 can acquire the route assignment information for the vehicle 161. By receiving the frequency band f3, the vehicle 162 can acquire the route assignment information for the vehicle 162. That is, the vehicle 160 can acquire the route assignment information of the vehicle and can receive the route assignment information of the nearby vehicle at the same time. Here, the band reservation at two times is performed for one band reservation request to the base station, but is not limited to the two times. In addition, although the frequency bands have been described as an example of the resources, if the communication is LTE, the information indicating the resources may be C-RNTI, MCS, or a resource block, and if the communication is communication based on code encoding, the information indicating the resources may be a code.

As illustrated in FIG. 28, a communication area 170, a communication area 171, and a communication area 172 schematically show areas capable of receiving transmissions to the vehicle 160, the vehicle 161, and the vehicle 162, respectively. For each vehicle position at time t2 indicated by band reservation from the route assignment server 200, the assigned communication areas can be simultaneously received in each nearby vehicle. When the route assignment information is notified, if a distance between the vehicles traveling in the vicinity at the traveling time in the route assignment information is long and it is assumed that the transmission of the route assignment for each cannot be received, the route assignment server 200 notifies the route assignment information of the nearby vehicle when the route assignment information for each is notified.

Therefore, the vehicle can receive the route assignment information for the vehicle and can also receive the route assignment information about the nearby vehicle.

### Second Embodiment

A difference from the first embodiment will be mainly described with reference to a second embodiment.

(Summary of Second Embodiment)

Elements constituting a transportation society are not just roads and vehicles. Pedestrians are also elements constituting the transportation society. There are traffic accidents with pedestrians as a problem in vehicle travel. Among pedestrians in a traffic accident, the proportion of elderly people is high, accounting for about 70% of death accidents. Even though there are individual differences, everyone beyond a certain age begins aging unconsciously and various functions such as exercise ability, visual ability, or judgment ability are weakened. This change is moderate and it is hard to be aware of gradual change in daily life. Without being aware of this change, people cross the road with the same intention as when they are young. However, in reality, the walking speed is slow due to the decline in the exercise capacity, it becomes easy to fall down, the visual acuity declines due to the deterioration of the visual ability, the field of vision becomes narrow, the vehicle becomes difficult to see, the judgment after the vehicle is seen due to the decline in the judgment ability is late, and when one pays attention to one thing, it is hard to pay attention to another thing. As a result, the rate at which a traffic accident occurs is high.

In recent years, extending the healthy life expectancy has been known, and as one of the efforts, moderate exercise such as daily walking is recommended. This reduces the rate of decay of various functions due to aging, and as a result, it is intended to extend the period during which it is possible to live without needing care.

On the other hand, there is a walking assistance device from the viewpoint of assisting the lowering of the walking ability due to the decay of the exercise function. It is a stick in a simple way, and there are pushed cars that also become chairs. These are trying to compensate for the weakness of the muscular strength of the legs with muscles of hands. The speed of movement depends on the muscles such as his/her legs and arms. On the other hand, in recent years, consideration has been made on a walking assistance device having a device (artificial muscle) for assisting muscles themselves. Examples of such walking assistance devices include those composed only of artificial muscles, those composed of artificial muscles and exoskeletons serving as frameworks, and the like. In addition, as one of the decay of the functions due to aging, there is a decline in a balance function. This decay induces falls and causes fractures. For this reason, as a walking assistance device for the elderly, a function that always keeps balance so as not to tumble is required for the weakening of the balance function of the user. This makes it possible to walk faster than walking with a weakened leg muscle. As a result, it is possible to enjoy the same wide range of activities as young, which is considered to lead to extension of healthy life.

By using a walking assistance device having artificial muscles, the walking speed increases and the range of action becomes wider. Meanwhile, nevertheless, the visual function, the judgment function, and the like have remained weakened, it is difficult to respond instantaneously to things that appeared instantaneously, or when an attention is directed to another thing for a moment, one can forget other things. This means that a person forgets a place where it should stop, suddenly starts to move, pops out to the roadway, and the risk of meeting the accident increases as the walking ability increases.

As a solution to this pop-out, (1) a method in which vehicle has various sensors, a pedestrian is detected by the sensor, and a collision avoidance is performed, (2) a method in which a pedestrian carries a device that issues a signal including position information and a traveling vehicle receives the signal, thereby warning a pop-out an performing a predicted traveling before the pedestrian pops out (see Japanese Patent No. 4321068), (3) a monitoring sensor is arranged on a road side, a pedestrian on a road which is a blind spot from the traveling vehicle is detected by the sensor, the detected information is notified to the traveling vehicle, and a pop-out is warned and a predicted traveling is performed, based on the notification (see Japanese Patent No. 4797854), and the like have been proposed.

However, considering a pedestrian who forgets to stop or suddenly starts moving at a place where the pedestrian should stop, the traveling vehicle will always travel on the assumption of pop-out. In other words, when there is a pedestrian at a place where there is no barrier such as a guardrail between the sidewalk such as a crosswalk and a roadway, a traveling vehicle will always slow down.

In addition, in any avoidance method, it is assumed that there is a sufficient space to avoid in the roadway. For this reason, in an environment where the traveling vehicles are densely packed, when forcibly trying to avoid collision with a pedestrian, there is a danger of developing into multiple accidents involving surrounding vehicles.

A walking assistance device according to a second embodiment includes a walking assistance power unit configured to assist a walking of a user, a communication unit configured to communicate with a server device through a network, and a processing unit configured to acquire, from the server device, assignment information indicating an area on a road on which a vehicle travels by automatic driving. The processing unit predicts the movement of the user, determines whether the user contacts the vehicle based on the movement prediction result and the assignment information, and if it is determined that the user contacts the vehicle, controls the walk assistance power unit so that the user does not contact the vehicle, and/or performs notification to the vehicle.

(System Configuration)

FIG. 29 is a diagram illustrating a configuration of a system according to the second embodiment.

As illustrated in FIG. 29, as in the first embodiment, the vehicle 100 is an automatically driven vehicle and travels according to the route assignment by the route assignment server 200. A system according to the second embodiment includes a walking assistance device 300. The walking assistance device 300 receives the route assignment that the route assignment server 200 transmits to the vehicle 100. The walking assistance device 300 determines the contact with the vehicle based on the operation state of the device and the received route assignment. The walking assistance device 300 examines an avoidance method of avoiding the contact with the vehicle, based on the determination, and transmits the avoidance method to the vehicle 100. The vehicle 100 travels based on the avoidance method from the walking assistance device 300.

(Configuration of Walking Assistance Device)

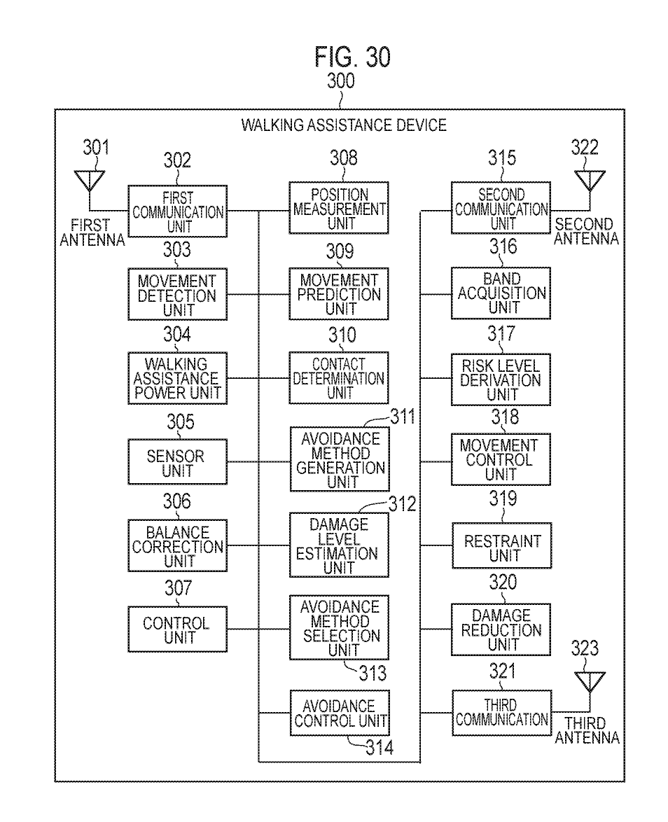

FIG. 30 is a diagram illustrating an example of a configuration of a walking assistance device 300 according to the second embodiment.

As illustrated in FIG. 30, the walking assistance device 300 includes an antenna 301, a first communication unit 302, a movement detection unit 303, a walking assistance power unit 304, a sensor unit 305, a balance correction unit 306, and a control unit 307, and performs auxiliary control in basic walking. The first communication unit 302 wirelessly connects with the base station 400 through the antenna 301. The movement detection unit 303 detects the movement of the wearer of the walking assistance device 300. The walking assistance power unit 304 provides auxiliary power to walking of the wearer (user). The sensor unit 305 arranges sensors inside and outside the walking assistance device 300. The balance correction unit 306 keeps balance so that the wearer does not fall down. The control unit 307 controls walking assistance.

Furthermore, the walking assistance device 300 includes, as elements constituting the processing unit, a position measurement unit 308, a movement prediction unit 309, a contact determination unit 310, an avoidance method generation unit 311, a damage level estimation unit 312, an avoidance method selection unit 313, an avoidance control unit 314, a band acquisition unit 316, a second communication unit 315, and a second antenna 322. The position measurement unit 308 measures the position of the device itself. The movement prediction unit 309 performs movement prediction. The contact determination unit 310 determines the contact with the vehicle based on the route assignment information of the vehicle from the route assignment server 200 and the prediction of the movement prediction unit 309, which are received by the first communication unit 302. The avoidance method generation unit 311 generates candidates of avoidance methods for the contact. The damage level estimation unit 312 estimates the damage degree of any person or thing caused when the avoidance method is performed. The avoidance method selection unit 313 selects an avoidance method based on the damage degree estimated by the damage level estimation unit 312. The avoidance control unit 314 performs avoidance control based on the avoidance method selected by the avoidance method selection unit 313. The band acquisition unit 316 acquires a transmission band based on transmission band assignment information received by the first communication unit 302 and a position acquired by the position measurement unit 308. The second communication unit 315 transmits the avoidance method to the vehicle based on the transmission band acquired by the band acquisition unit 316.

Therefore, the contact with the vehicle is determined, and if it is estimated to be in contact, the avoidance method is selected. If the cooperation with the vehicle is necessary in avoidance, the avoidance method is notified to the vehicle and the voidance movement is performed. Furthermore, the walking assistance device 300 suppresses the possibility of contact by restricting the operation according to a risk degree by a risk level derivation unit 317 configured to derive a risk level at a place where the walking assistance device 300 is located and a movement restriction unit 318 configured to restrict the movement in the walking assistance based on the risk level by restricting the operation according to the degree. In addition, the walking assistance device 300 includes a restraint unit 319 configured to restrain freedom of the wearer's hands and/or arms, a damage reduction unit 320 configured to reduce a damage in a collision and the like, a third communication unit 321 configured to communicate with a body measurement unit arranged in the wearer's body, and a third antenna 323. Therefore, it is possible to reduce the damage of the wearer caused when the walking assistance device 300 comes into contact with the vehicle, the ground, and the like in the avoidance movement, acquire the information of the wearer's body when damaged, and transmit the acquired information to a rescue destination.

(Configuration of Vehicle)

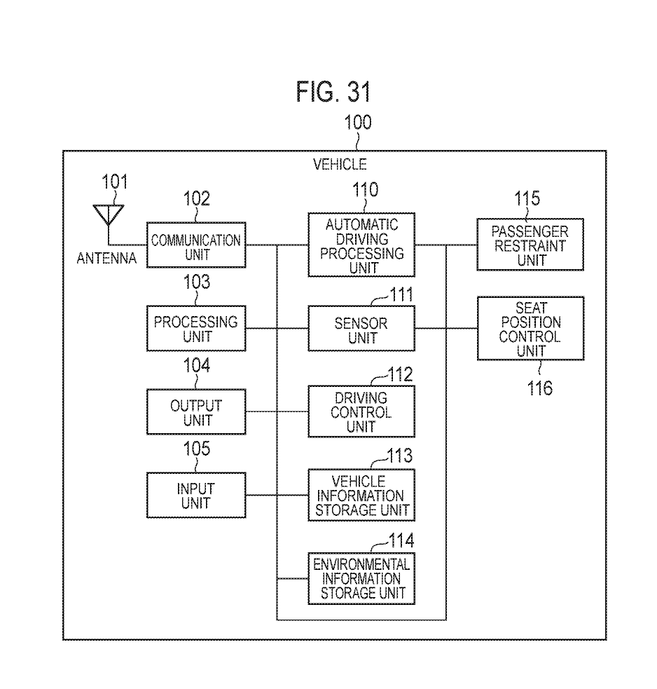

FIG. 31 is a diagram illustrating an example of the configuration of the vehicle 100 according to the second embodiment.

As illustrated in FIG. 31, the vehicle 100 further includes a passenger restraint unit 115 and a seat position control unit 116. The passenger restraint unit 115 restrains the passenger according to a situation such as a traffic accident. The seat position control unit 116 controls a position of a seat on which the passenger is seated.

When the avoidance method is received from the walking assistance device 300 or the like, the processing unit 103 instructs the automatic driving processing unit 110 to perform the avoidance method. The processing unit 103 calculates the damage degree of the vehicle based on the avoidance method. Based on the state of damage, the processing unit 103 instructs the passenger restraint unit 115 to restrain the passenger to the seat so that the damage to the passenger is reduced. In addition, the processing unit 103 instructs the seat position control unit 116 to move the seat position. If the avoidance method and/or the rescue request transmitted by the walking assistance device 300 is received, the processing unit 103 transmits information of the avoidance method and/or the rescue request to the route assignment server 200.

(Configuration of Route Assignment Server)

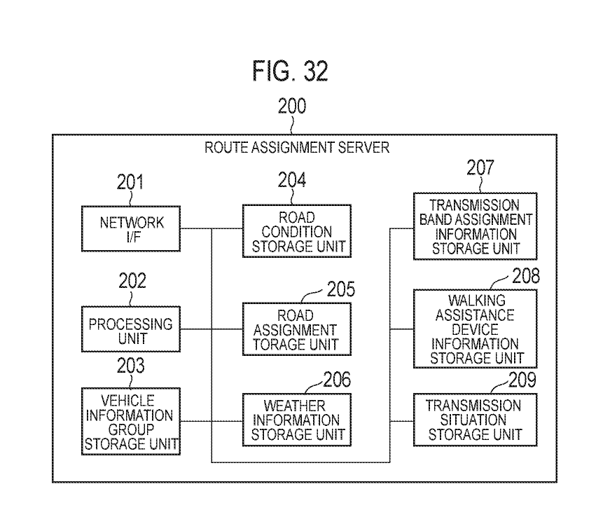

FIG. 32 is a diagram illustrating an example of the configuration of the route assignment server 200.

As illustrated in FIG. 32, the route assignment server 200 further includes a transmission band assignment information storage unit 207, a walking assistance device information storage unit 208, and a transmission state storage unit 209. The transmission band assignment information storage unit 207 stores transmission band assignment information for the walking assistance device 300. The walking assistance device information storage unit 208 stores information about the walking assistance device 300, information about the wearer of the walking assistance device 300, and information about avoidance processing of the walking assistance device 300. The transmission state storage unit 209 stores the transmission state of the walking assistance device.

The processing unit 202 performs the assignment of the transmission band to the range where the walking assistance device 300 is located, based on the traveling condition of the vehicle traveling in the vicinity and the possibility of encountering a traffic accident of the walking assistance device 300. The processing unit 202 holds the assignment result in the transmission band assignment information storage unit 207 and notifies the assignment result through the network I/F 201. When the information about the walking assistance device 300 is received, the processing unit 202 holds the received information in the walking assistance device information storage unit 208. The processing unit 202 shares, if necessary, information with various servers through the network I/F 201. For example, when the damage condition of the wearer and the physical information are included as the information about the walking assistance device 300 and the wearer of the walking assistance device is damaged along with the avoidance movement, the physical information is transmitted to a server of a medial institution which is the destination of the wearer. If the processing unit 202 receives the avoidance request to the vehicle 100 by the walking assistance device 300, the processing unit 202 holds the information in the transmission state storage unit 209. The processing unit 202 performs the transmission-prohibition continuation transmission to the walking assistance device 300 in the vicinity of the accident site through the network I/F 201 until the related processing such as accident processing accompanying the avoidance request is completed. Upon completion of the related processing, the processing unit 202 transmits transmission permission to the walking assistance device in the vicinity of the accident site through the network I/F 201.

(Operation of Walking Assistance Device)

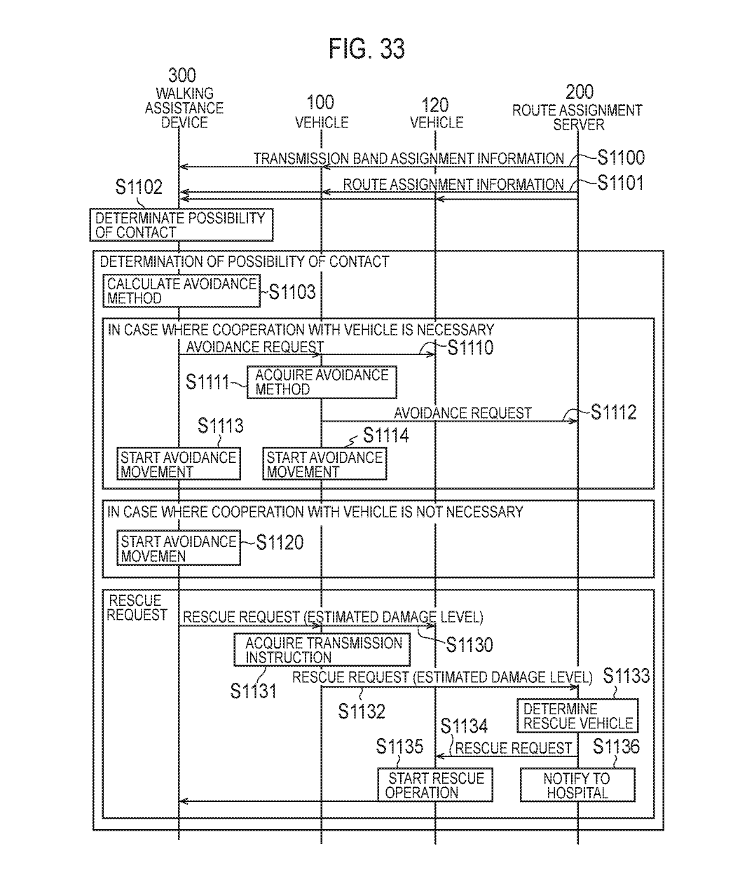

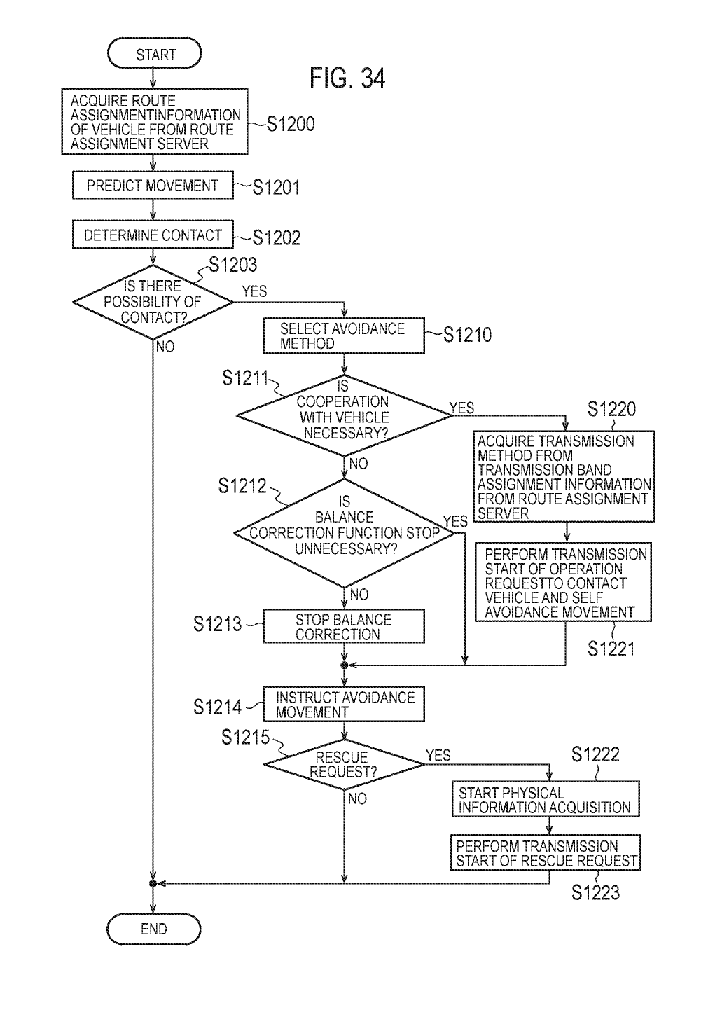

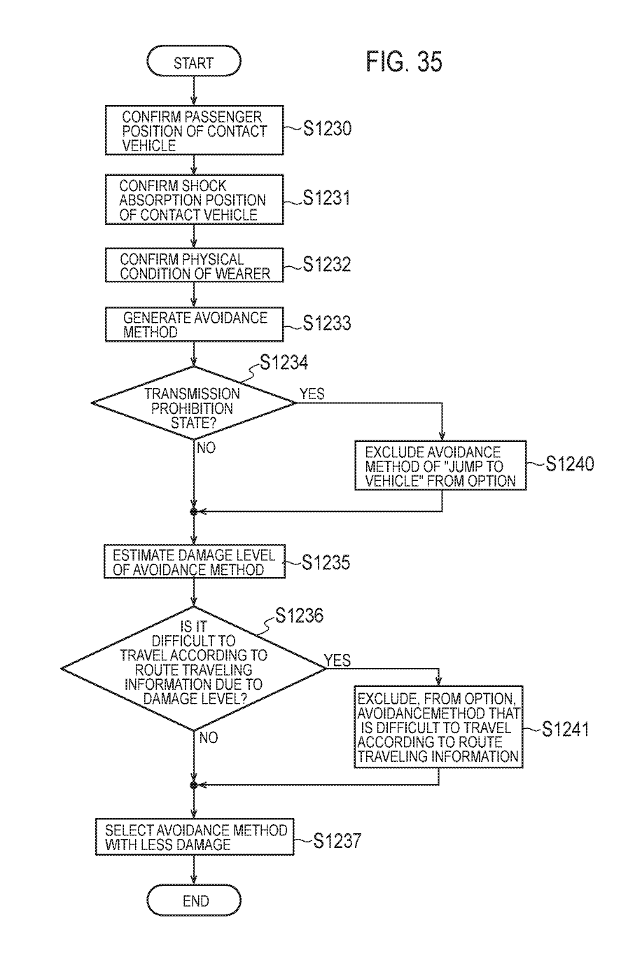

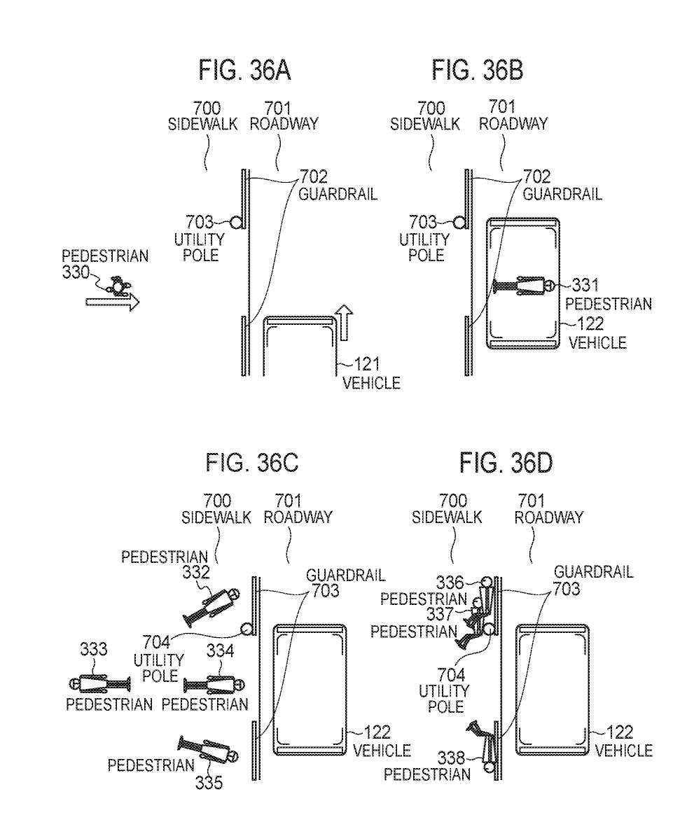

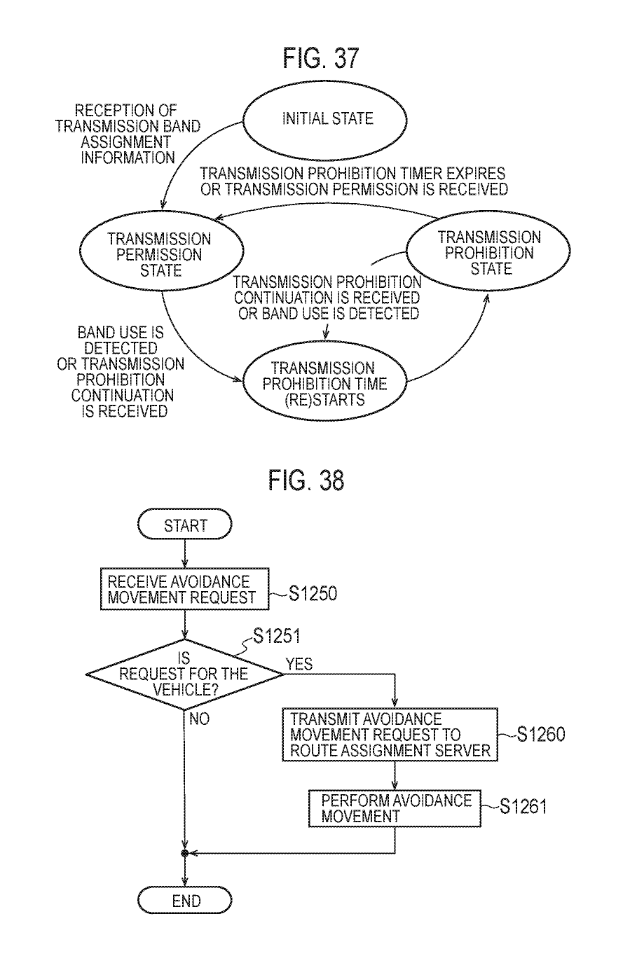

FIG. 33 is a diagram illustrating an example of a flow of vehicle contact avoidance of the walking assistance device. FIG. 34 illustrates an example of a flowchart of avoidance processing of the walking assistance device. FIG. 35 illustrates an example of a flowchart of selection of an avoidance method of the walking assistance device. FIGS. 36A to 36D are diagrams illustrating examples of avoidance methods. FIG. 37 is a diagram illustrating an example of a state transition diagram of a transmission permission/prohibition state.

As illustrated in FIG. 33, the route assignment server 200 transmits transmission band assignment information (S1100) and transmits route assignment information (S1101). The transmission band assignment information has a transmission band (radio resource) and information indicating a range (geographical range) to which the transmission band is applied. The information indicating the range to be applied has, for example, a center position and a coefficient related to the width to be applied (width coefficient). The walking assistance device 300 and the vehicles 100 and 120 receive the transmission band assignment information and the route assignment information. The walking assistance device 300 determines a possibility of contact with the vehicle based on the route assignment information (S1102).

If the walking assistance device 300 determines that there is a possibility of contact, the walking assistance device 300 calculates an avoidance method (S1103). In the calculated avoidance method, if the cooperation with the vehicle is necessary, the walking assistance device 300 transmits an avoidance request to the vehicles 100 and 120 in the transmission band (S1110). If the avoidance request is for the vehicle 100, the vehicle 100 acquires the avoidance method (S1111). The vehicle 100 transmits the avoidance request to the route assignment server 200 (S1112). The walking assistance device 300 and the vehicle 100 start avoidance movement (S1113, S1114).

If the cooperation with the vehicle is unnecessary, the walking assistance device 300 starts avoidance movement (S1120). If it is estimated that rescue against injury is necessary, the walking assistance device 300 transmits a rescue request having an estimated damage state (S1130). The vehicle 100 having received the rescue request acquires a transfer instruction (S1131) and transmits the rescue request to the route assignment server 200 (S1132). The route assignment server 200 determines a rescue vehicle from vehicles in the vicinity of a place requiring rescue according to the estimated damage condition of the received rescue request (S1133). The route assignment server 200 transmits the rescue instruction (S1134). The vehicle 120 having received the rescue instruction starts a rescue operation (S1135). The route assignment server 200 notifies a hospital that a damaged condition of an injured person to be rescued is a destination (S1136).

As illustrated in FIG. 34, the walking assistance device 300 receives the route assignment information of the vehicle from the route assignment server (S1200). The movement prediction unit 309 predicts the movement of the walking assistance device 300 (S1201). The contact determination unit 310 determines contact based on the route assignment information and the movement prediction (S1202).

As a result of the determination, if it is determined that there is a possibility of contact (S1203: Yes), the avoidance method selection unit 313 selects an avoidance method (S1210). In the selected avoidance method, if the cooperation with the vehicle is necessary (S1211: Yes), the walking assistance device 300 acquires the transmission band assignment information from the route assignment server 200 and the transmission band based on the current position (S1220), and performs the transmission start of the avoidance operation to the contact vehicle and the avoidance method having the self avoidance movement in the transmission band (S1221).

If the cooperation with the vehicle is unnecessary (S1211: No) and a balance correction function stop is not unnecessary (S1212: No), the balance correction unit 306 stops the balance correction (S1213). The avoidance control unit 314 instructs the walking assistance power unit 304 to perform an avoidance movement (S1214). If it is determined that the rescue is necessary based on the damage degree with respect to the selected avoidance method estimated by the damage level estimation unit 312 (S1215: Yes), the walking assistance device 300 starts the acquisition of the wearer's physical information (S1222), and the estimated damage state and the rescue request having the measured physical information start to be transmitted (S1223). The stop is performed if the notification of the physical information is continuously performed and is released from the walking assistance device, or if the request to stop the notification is received from the route assignment server 200 or the like.

As illustrated in FIG. 35, the walking assistance device 300 confirms the route assignment of the contact vehicle from the received route assignment information, and if there is a passenger position of the contact vehicle in route information, the walking assistance device 300 confirms the passenger position (S1230). If the route information includes information such as a shock absorption position of the contact vehicle or information (for example, the type of the vehicle) capable of acquiring the information about the shock absorption position, the walking assistance device 300 confirms the shock absorption position and the like of the contact vehicle (S1231). The walking assistance device 300 confirms the physical condition of the wearer of the walking assistance device 300 (S1232).

In consideration of the passenger position, the shock absorption position, the wearer's physical condition, and the like, the avoidance method generation unit 311 generates one or more supposed avoidance methods (S1233). As an option of the avoidance method, the avoidance movement by the walking assistance device is added. If the transmission permission/prohibition state is the transmission prohibition state (S1234: Yes), the avoidance method of pop-out to the vehicle from the generated avoidance method is excluded (S1240). The damage level estimation unit 312 estimates the damage degree with respect to each avoidance method (S1235). As the damage degree to be estimated, there are the damage degree of the pedestrian wearing the walking assistance device, the damage degree of the vehicle, the damage degree of the surrounding pedestrians, and the damage degree of the passenger of the vehicle. If the vehicle determines that it is difficult to continue traveling based on the route assignment information due to the damage degree after the contact (S1236: Yes), the difficult avoidance method is excluded from the options (S1241). The avoidance method selection unit 313 selects the avoidance method with less damage from among the options of the remaining avoidance methods (S1237).

The avoidance method with less damage is, for example, an avoidance method in which the greatest damage among the damages of the pedestrian and the passenger is minimized, an avoidance method of minimizing damage of the pedestrian and the passenger, an avoidance method in which the sum of the periods required to completely cure the damage of the pedestrian and the passenger is shortest, or an avoidance method in which the cost for repair, treatment, or the like is minimized for all damages.

As illustrated in FIGS. 36A to 36D, FIG. 36A illustrates a state before the avoidance action. There are a sidewalk 700 and a roadway 701. On the sidewalk 700, there are a pedestrian 330 wearing the walking assistance device 300, a guardrail 702, and a utility pole 703. On the roadway 701, there is a vehicle 121. The pedestrian 330 moves toward the roadway 701. The vehicle 121 travels upward.

FIG. 36B illustrates avoidance of riding on the vehicle. The pedestrian 330 in FIG. 36 A moves to the roadway 701 as it is, jumps up and rides on the traveling vehicle 122 (pedestrian 331).

FIG. 36C illustrates avoidance by stopping the operation of at least a part of the walking assistance device 300. For example, the pedestrian 330 in FIG. 36 A stops the function of the balance correction unit 306 and then causes the pedestrian 330 to sit on the sidewalk 700 or to gently overturn it so as to avoid jumping out to the roadway 701. As the falling direction, there are a left side (pedestrian 332), a front side (pedestrian 334), a right side (pedestrian 335), and a rear side (pedestrian 333) with respect to the pedestrian 330. In the following, a gentle falling (simply referred to as “falling”) will be described.

FIG. 36D illustrates avoidance by stopping the movement of the pedestrian 330 by contact with an obstacle. For example, the pedestrian 330 in FIG. 36A stops the function of the balance correction unit 306 and contacts the surrounding fixed object (guardrail 702, utility pole 703) on the sidewalk 700, so as to avoid jumping out to the roadway 701. If the pedestrian 336 and the pedestrian 338 contact the guard rail 703, the pedestrian 337 contacts the utility pole 704. In the following, such an operation is simply referred to as “contact”.

Furthermore, with respect to falling (FIG. 36C) and contact (FIG. 36D), if it is possible to intentionally perform an operation in which the falling avoidance becomes unavoidable due to the performance of the balance correction 306 while keeping the function of the balance correction unit 306, falling and contacting in the operation state of the function of the balance correction 306 is included as candidates for the avoidance method. The avoidance method also includes an operation by the restraint unit 319 and the damage reduction unit 320. The avoidance method generation unit 311 generates riding (FIG. 36B), falling (FIG. 36C), contact (FIG. 36D), and other avoidance methods (stopping, changing the moving direction, or the like) as candidates for avoidance methods, and the damage level estimation unit 312 performs an estimation calculation of the damage degree with respect to the generated candidates for the avoidance methods (riding (FIG. 36B), falling (FIG. 36C), contact (FIG. 36D), and other avoidance methods) and the case where the avoidance control unit does not perform the avoidance movement. The avoidance method selection unit 313 selects an avoidance method with the least damage degree, based on the result of the estimation calculation.

As illustrated in FIG. 37, when transmission band assignment information is received at the initial state in the transmission permission/prohibition state, the state is shifted to the transmission permission state. In the case of the transmission permission state, the walking assistance device 300 becomes selectable to ride on the vehicle 100 as the avoidance method, and the avoidance method can be transmitted to the vehicle 100. In the transmission permission state, if band use is detected by transmission to the vehicle 100 or the like by another walking assistance device 300, the state is shifted to the transmission prohibition timer (re)operation, the transmission prohibition timer is operated, and the state is shifted to the transmission prohibition state. In the transmission prohibition state, the walking assistance device 300 disables transmission to the vehicle 100, and disables the selection of the riding on the vehicle 100 as the avoidance method. In the transmission prohibition state, if the transmission prohibition continuation is received, the state is shifted to the transmission prohibition timer (re)operation, the transmission prohibition timer is restarted, and the state is shifted to the transmission prohibition state. If the transmission prohibition timer expires or the transmission permission is received in the transmission prohibition state, the state is shifted to the transmission permission state.

(Operation of Vehicle)

FIG. 38 is a flowchart illustrating an example of a flowchart of a vehicle upon walking assistance device avoidance processing.

As illustrated in FIG. 38, if the avoidance movement request is received (S1250), the vehicle 100 confirms whether the request is for the vehicle 100, and if the request is for the vehicle 100 (step S1251: Yes), the vehicle 100 transmits the avoidance request to the route assignment server 200 (S1260) and starts the received avoidance movement (S1261).

(Operation of Route Assignment Server)

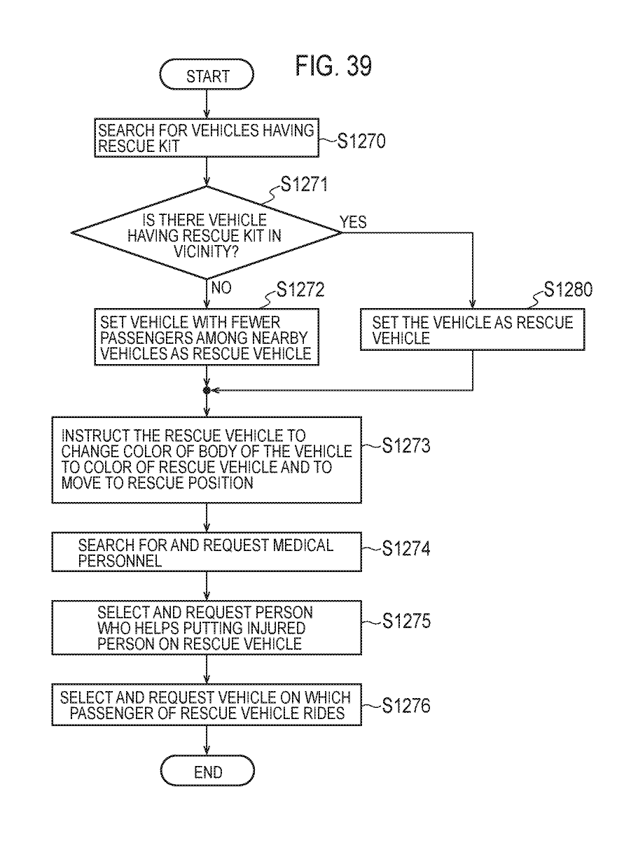

FIG. 39 is a flowchart illustrating an example of a flowchart of a route assignment server upon walking assistance device avoidance processing.

As illustrated in FIG. 39, if the rescue request is received, the route assignment server 200 searches for a vehicle having a rescue kit containing medical instruments and the like used for rescue from a vehicle near or coming from a place requesting rescue (S1270). If there is a vehicle having a rescue kit in the vicinity (S1271: Yes), the route assignment server 200 determines vehicles to be selected based on information (for example, gender, age, physical condition, or the like) and positions of passengers among vehicles having a rescue kit (S1280). If there is no vehicle having a rescue kit (S1271: No), the route assignment server 200 sets a vehicle with fewer passengers among the nearby vehicles as a rescue vehicle (S1272). The route assignment server 200 instructs the rescue vehicle and the selected vehicle to move to the rescue place (S1273). At this time, the vehicle may be changed to a body color for a rescue vehicle, or an instruction to turn on a lamp or the like indicating that the vehicle is a rescue vehicle may be instructed. The route assignment server 200 searches for and requests medical personnel (S1274). The route assignment server 200 selects and requests a person who helps bringing the injured person to the rescue vehicle (S1275). The route assignment server 200 arranges for a vehicle instead of a vehicle that has become a rescue vehicle for a passenger on a vehicle that become a rescue vehicle (S1276).

(Application Range of Transmission Resource)

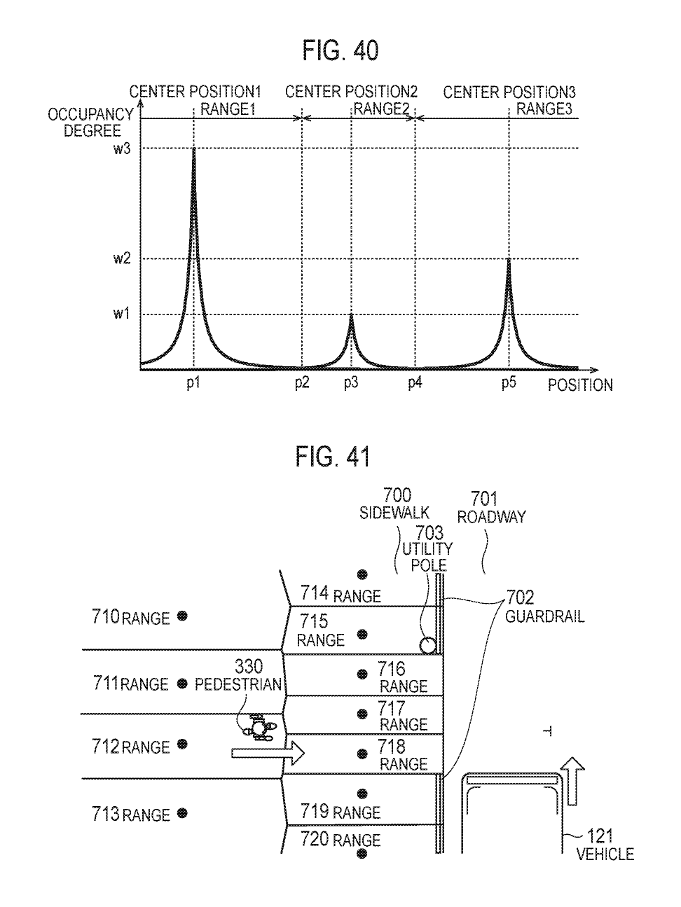

FIG. 40 is a diagram illustrating an example of an application range. FIG. 41 is a diagram illustrating an example of an application range.

As illustrated in FIG. 40, a horizontal axis of a graph represents the position and a vertical axis represents the occupancy degree. Three ranges are marked on the graph. The center position of the range 1 is p1, and the width coefficient is w3. The center position of the range 2 is p3, and the width coefficient is w1. The center position of the range 3 is p5, and the width coefficient is w2. For which range the certain position p belongs, the occupancy degree w of each range at the position p is calculated, and the occupancy degree w belong to the highest range. The occupancy degree w is calculated by the following equation.

$$w = \frac{width coefficient}{{( 1 + \vert p - center position \vert )}^{2}} \qquad [ Math . 1 ]$$

A boundary between the range 1 and the range 2 is the position p2, and a boundary between the range 2 and the range 3 is the position p4.

As illustrated in FIG. 41, the sidewalk 700 is divided into ten application ranges (710 to 720). The center position of each applicable range is indicated by a black circle. Here, four width coefficients of the ranges 710, 711, 712, and 713 are the largest, four width coefficients of the ranges 714, 715, 719, and 720 are large, and the width coefficients of the ranges 716, 717, and 718 are the smallest. The pedestrian 330 is in the range 712. Therefore, if the pedestrian 330 transmits the avoidance method to the vehicle 121, the transmission band (radio resource) set for the range 712 is used.

(Example of Operation Restriction)

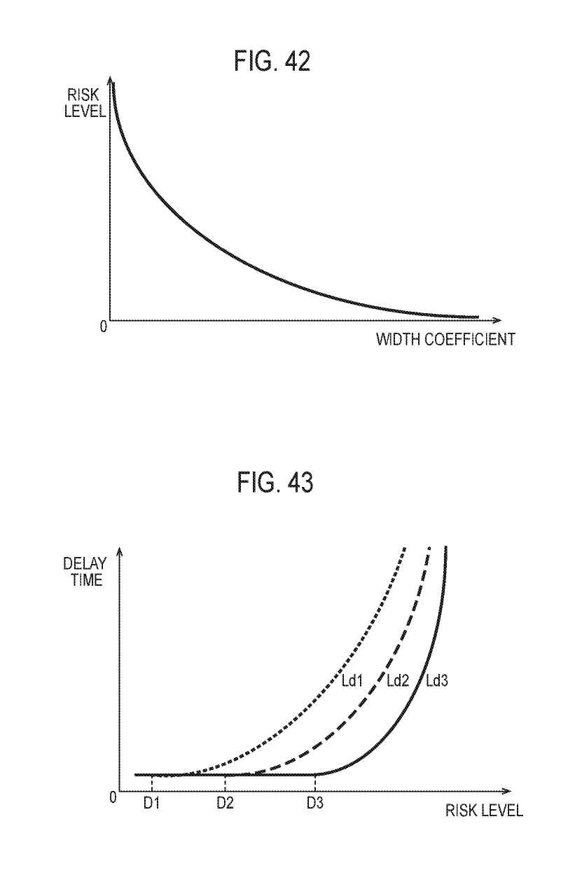

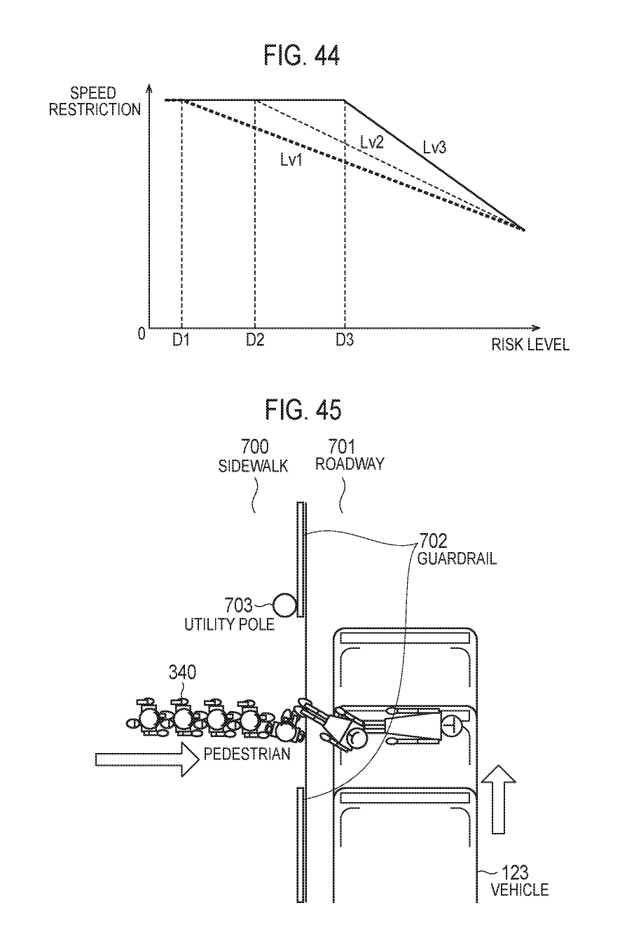

FIG. 42 is a diagram illustrating an example of a risk level. FIG. 43 is a diagram illustrating an example of operation restriction. FIG. 44 is a diagram illustrating an example of operation restriction.

As illustrated in FIG. 42, if the width coefficient of the range is large, that is, the range is wide, the risk level is assumed to be low. Conversely, if the width coefficient of the range is small, that is, the range is narrow, the risk level is assumed to be high.

As illustrated in FIG. 43 and FIG. 44, as the operation restriction of the walking assistance device 300, as the risk level increases, the delay time during which the assistance operation reacts to the movement of the wearer of the walking assistance device 300 is lengthened (see FIG. 43). In addition, as the risk level increases, the limit speed of the walking speed that can be output in a state of wearing the walking assistance device 300 is lowered. As illustrated in FIG. 43 and FIG. 44, the solid lines Ld3 and Lv3 are normal operation restrictions. On the other hand, in the transmission prohibition state, the operation restriction is the thin broken lines Ld2 and Lv2. In addition, if power held in an internal battery of the walking assistance device is lower than power required for the avoidance movement, the operation restriction is the thick wave lines Ld1 and Lv1.

(Example of Notification to Vehicle)

FIG. 45 is an example illustrating an avoidance method of notifying the vehicle.

As illustrated in FIG. 45, if the walking assistance device 300 selects riding on a vehicle as the avoidance method, the walking assistance device 300 transmits the avoidance method to the vehicle. The avoidance method includes data indicating the position and posture of the walking assistance device 300 (pedestrian 340) for each minute period and data indicating the position of the vehicle. As the data indicating the position and posture of the walking assistance device 300, for example, there are a numerical value (identifier) indicating the shape of the walking assistance device 300 (or the pedestrian 340), an enlargement/reduction ratio (numerical value indicating the same) with respect to the reference size, the position of the center of gravity and posture direction for each minute period.

(Example of Width of Application Range of Transmission Resource)

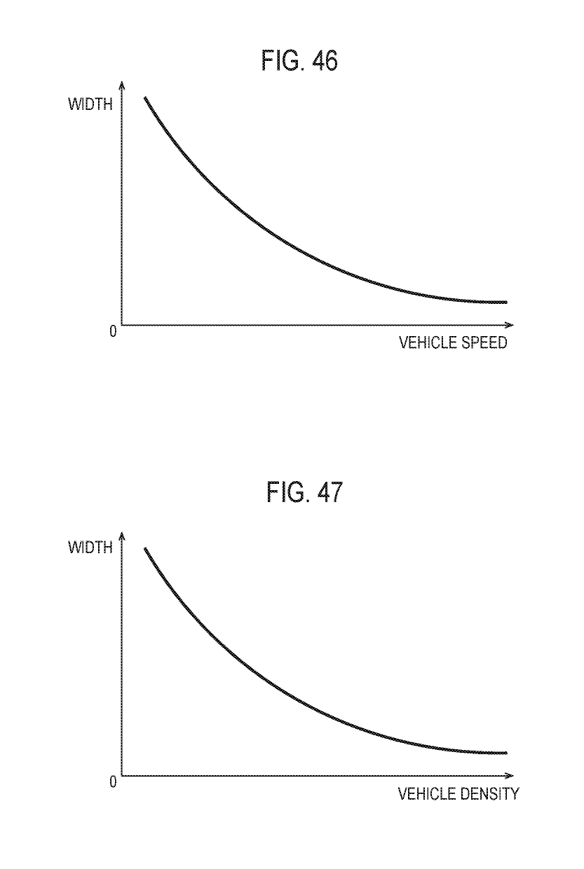

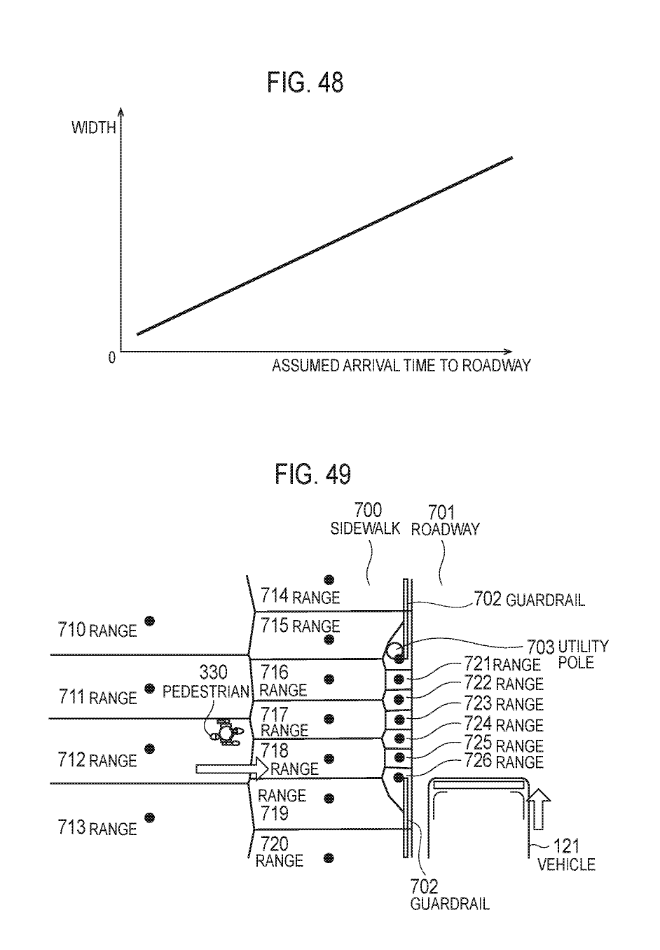

FIG. 46 and FIG. 47 are diagrams illustrating an example of a vehicle situation and a width of an application range. FIG. 48 is a diagram illustrating an example of a width of an application range. FIG. 49 is a diagram illustrating an example of an application range.

As illustrated in FIG. 46, as the vehicle speed of the nearby roadway is higher, the width of the application range becomes narrower. As illustrated in FIG. 47, as the vehicle density of the nearby roadway is higher, the width of the range becomes narrower. As illustrated in FIG. 48, the assumed arrival time until entering the nearby roadway is shorter, the width of the range becomes narrower. The assumed arrival time is the arrival time to the roadway when traveling at a certain moving speed, and for example, the assumed arrival time becomes short if there is nothing on the way up to the roadway. On the other hand, if there is a guardrail or the like up to the roadway, it has to get over the guardrail or detour and enter the roadway, and the time it takes to arrive at the roadway become longer. In places where the time to get into the roadway is short, there is a possibility that any avoidance movement must be performed in any of the walking assistance devices therein. If multiple walking assistance devices attempt to use the band at the same time, the collision will occur. In order to avoid such a situation, the width of the range is narrowed so that each individual walking assistance device utilizes an individual band. On the other hand, if the vehicle speed is low and the density of the vehicle is low, even when entering the roadway, there is a high possibility that the contact can be avoided by self avoidance of the walking assistance device. In such a case, the width of the range is widened and the use of the band is alleviated.

As illustrated in FIG. 49, as compared with FIG. 41, if the vehicle density of the roadway 701 increases or the vehicle traveling speed increases, the width of the application range is narrowed. As a result, the range in the sidewalk 700 further increases the division from the range division of FIG. 41 to the ranges 721, 722, 723, 724, 725, 726, and 727.

(Example of Restraint Unit and Damage Reduction Unit)

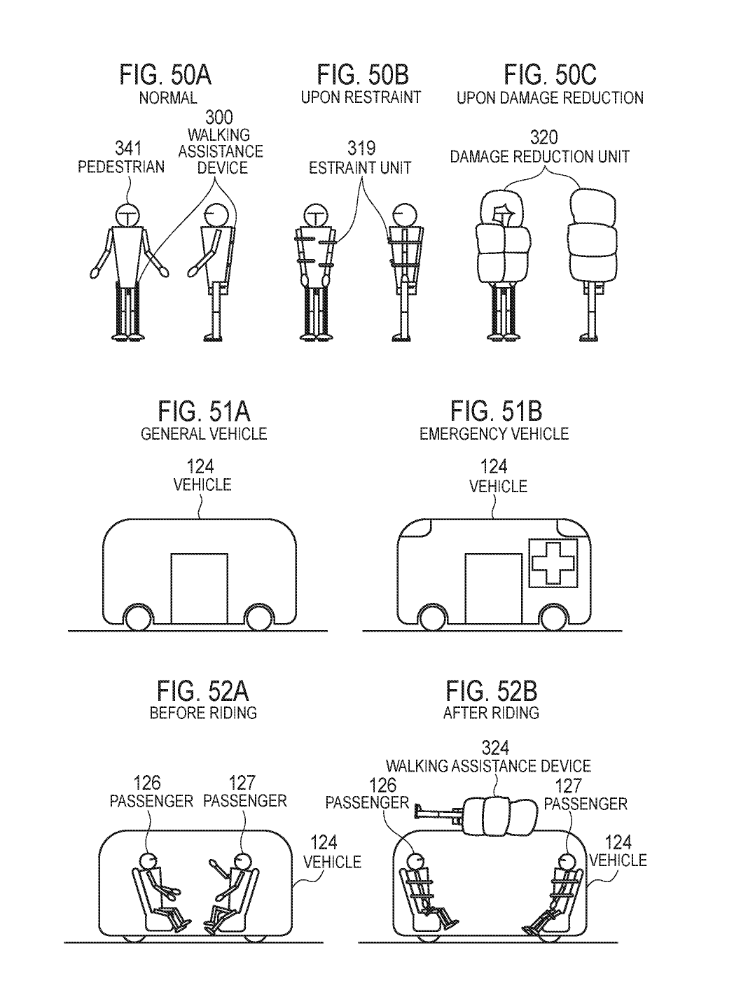

FIGS. 50A to 50C are diagrams illustrating examples of a restraint unit 319 and a damage reduction unit 320.

As illustrated in FIG. 50A to 50C, FIG. 50A illustrates a state in which the walking assistance device 300 is worn. FIG. 50B illustrates a state in which the restraint unit 319 of the walking assistance device 300 is activated. FIG. 50C illustrates a state in which the restraint unit 319 and the damage reduction unit 320 of the walking assistance device 300 are activated.

The pedestrian 341 wears the walking assistance device 300, and upon walking, the pedestrian 341 walks while receiving the walking assistance by the walking assistance device 300 (FIG. 50A). Along with the avoidance movement, the walking assistance device 300 activates the restraint unit 319 held on the back part and restrains the hands and arms of the pedestrian 341 with an arm for restraining from the back part (FIG. 50B). Furthermore, according to the timing of receiving the impact, the damage reduction unit 320 is activated, the head part from the back part is wrapped with the damage reduction member, and the body part from the arm and back part is wrapped with the damage reduction member. In addition, with respect to the leg part, the leg part from the exoskeleton part may be wrapped with the damage reduction member. This makes it possible to avoid fractures of the hand due to reflexive hand release when collapsed and to alleviate the impact on the body by activation of the damage reduction unit. In addition, the walking assistance device 300 is designed so that the place to receive the impact at the time of getting on, falling, or contact is most likely to absorb shock and the system is fixed so that it becomes a place (for example, back, side, or the like) where damage to the wearer is small. In addition, at the time of falling, a part of the restraining arm may be bent in a state of being curved toward the front of the wearer's chest. In this case, it rolls on the curved arm when it fell to the ground, and stops at the back. This makes it possible to relieve impact. The estimation is performed by taking into account a case where the damage level estimation unit 312 estimates the damage degree, a case where the restraint unit 319 and the damage reduction unit 320 are not activated with respect to avoidance behaviors such as riding, falling, contact, or the like, a case where the restraint unit 319 is activated, a case where the restraint unit 319 and the damage reduction unit 320 are activated, and a case where the passive operation is performed.

(Example of Vehicle Body Color)

FIGS. 51A to 51B are diagrams illustrating examples of a vehicle body color.

As illustrated in FIGS. 51A to 51B, FIG. 51A is a diagram illustrating an example of a vehicle body color before shifting to an emergency vehicle. FIG. 51 is a diagram illustrating an example of a body color of a vehicle after transition to an emergency vehicle. The vehicle 124 arranges for a display member on the surface of the vehicle so that the vehicle body color can be changed. Before the vehicle 124 is selected as an emergency vehicle, the vehicle 124 constitutes the vehicle body color according to the preference of the passenger. For example, exterior design and interior design of the vehicle to ride are generated and displayed with a personal identifier described in the preference information held in the storage medium possessed by the passenger or the physical information attached to the body of the passenger (in the body), based on the preference information acquired from the server.

If selected as the emergency vehicle, the vehicle 124 displays exterior designs and interior designs set as the emergency vehicle regardless of the preference of the passenger. This makes it easy to understand that it is an emergency vehicle from inside and outside, and those who are instructed to help with rescue will soon find out where to bring the damaged person. In addition, the passenger of the vehicle selected as the rescue vehicle can recognize that it has been diverted to an emergency vehicle due to a change in the interior design, thereby knowing the action required before arrival by accessing the vehicle. In addition, similarly, by specifically designing the vehicle body color of the vehicle 123 on which the walking assistance device 300 rides, the rescuer can know the location of the damaged person as a factor and can perform the rescue operation immediately. In addition, similarly, by specifically designing the vehicle body color of the vehicle assigned for transfer, it becomes possible for a person who is requested to change a route to easily know a next vehicle after getting out of the vehicle assigned to the emergency vehicle. As a result, it is possible to act promptly.

As the vehicle body color, an interior/exterior design related to the specific application as described above is determined, and when the processing unit 103 displays the vehicle body color according to the preference of the passenger, the processing unit 103 determines whether it is a design that may be misunderstood as a design for a specific purpose, and if it is determined that there is a possibility of misunderstanding, excludes this from the display target.

(Example of Passenger Seat Control)

FIGS. 52A to 52B are diagrams illustrating examples of a passenger seat control.

As illustrated in FIGS. 52A to 52B, FIG. 52A illustrates an example of a seat condition of a passenger before a walking assistance device rides on. FIG. 52B illustrates an example of a seat condition of a passenger after a walking assistance device rides on.

Before the walking assistance device 342 rides on, the passengers 126 and 127 of the vehicle 124 move the seat to his/her preferred position and are freely sitting on the seat (FIG. 52A). As the walking assistance device 342 rides on, before getting on the vehicle, the passengers 126 and 127 are restrained by the passenger restraint unit 115 of the seat (see FIG. 31), and damage due to the riding of the walking assistance device 342, and for example, each seat is moved to the corner where the pillar is located at a place that is not easily damaged by the riding of the walking assistance device 342 (FIG. 52B). If the walking assistance device 342 rides on the vehicle 124, the walking assistance device 342 rides on the center part of the vehicle 124 where the risk of falling is the least, after the walking assistance device 342 rides. In addition, the walking assistance device 342 is caught by the vehicle 124 with a holding tool (for example, a hook) so as to avoid falling from the vehicle 124 after riding. The ceiling portion of the vehicle 124 is collapsed due to the weight of the walking assistance device 342 and the shock caused by the riding. On the other hand, the passengers 126 and 127 avoid damage by evacuating to the four corners inside the vehicle having pillars. The evacuation place of the passenger changes according to the riding position of the walking assistance device 342 and the vehicle structure. In addition, similarly to the walking assistance device 243, there may be a damage reduction unit configured to alleviate the shock to the passengers 126 and 127 of the vehicle 124. Furthermore, with respect to the movement of the seat, it may be performed not only when the walking assistance device 342 rides, but also when the vehicle 124 comes into contact with an obstacle.

(Example of Transmission Resource)

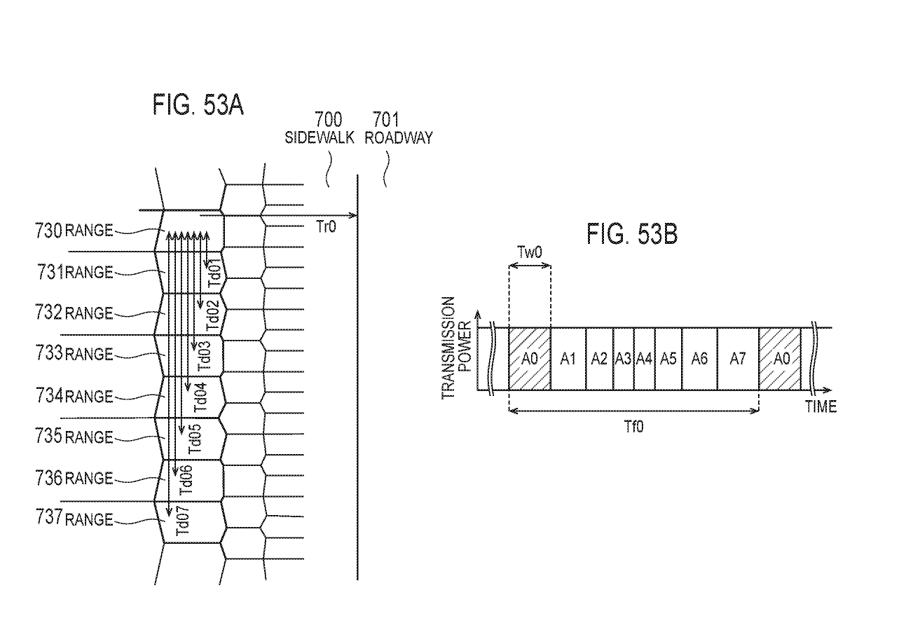

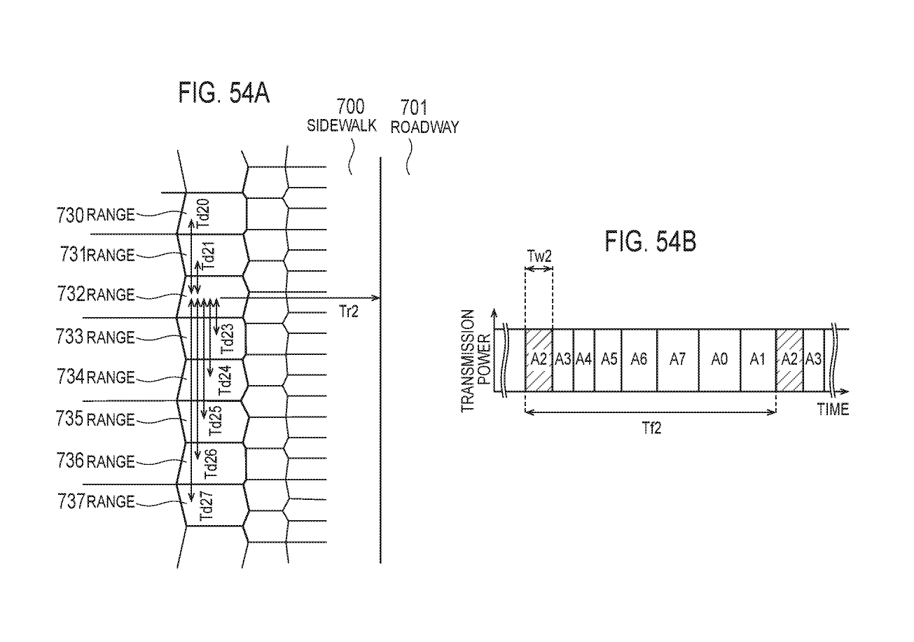

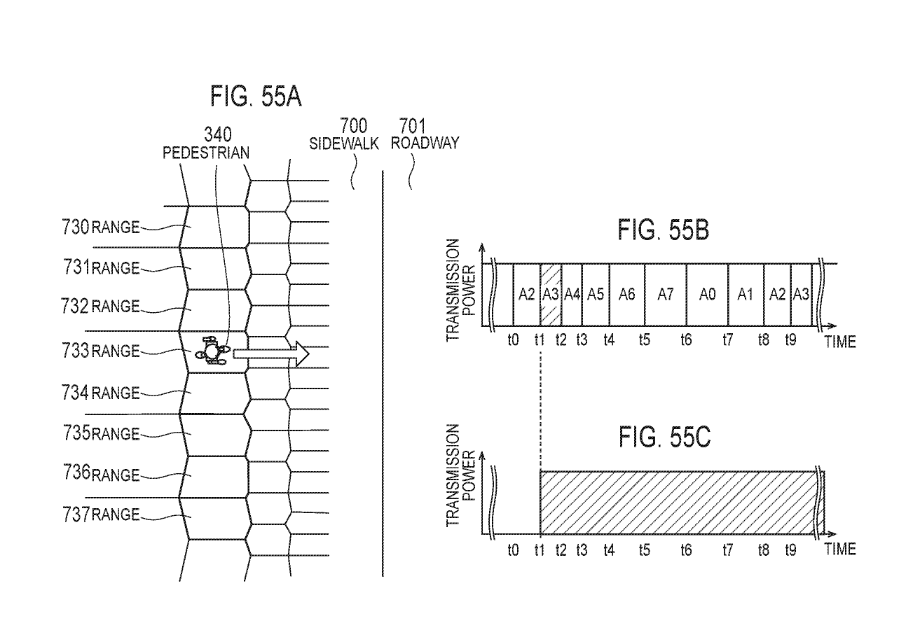

FIGS. 53A to 53B are diagrams illustrating examples of band assignment. FIGS. 54A to 54B are diagrams illustrating examples of band assignment. FIGS. 55A to 55C are diagrams illustrating examples of transmission by band assignment.

As illustrated in FIGS. 53A to 53B and FIGS. 54A to 54B, the sidewalk 700 has eight ranges 730, 731, 732, 733, 734, 735, 736, and 737. In the eight ranges, the same frequency band is set as the transmission band, and in the other ranges except for the eight ranges, the frequency band is not used. For example, it is assumed that there are no ranges other than the eight ranges to transmit using the same frequency band within a range at least capable of being received by a terminal that receives transmissions from any of the eight ranges. For the ranges 730, 731, 732, 733, 734, 735, 736, and 737, the assignment of the transmission bands occupied in each range is A0, A1, A2, A3, A4, A5, A6, and A7, and in the case of the transmission permission state, the walking assistance device 300 in each range performs transmission from the head of each specified band.

As illustrated in FIGS. 53A to 53B, for the range 730, the time interval Tw0 of A0 depends on the maximum transmission delay between the range 730 and another range using the same frequency band. For the range 730, the time interval Tw0 of A0 is determined based on the transmission delay Td07 between the range 730 and the maximum transmission delay range 737. For example, Tw0>Td07. In addition, the cycle Tf0 between the two A0s is determined depending on the assumed time Tr0 required for the walking assistance device 300 in the range 730 to move to the roadway 701. For example, Tf0<Tr0/2.

As illustrated in FIGS. 54A to 54B, for the range 730, the time interval Tw2 of A2 depends on the maximum transmission delay between the range 732 and another range using the same frequency band. For the range 732, the time interval Tw2 of A2 is determined based on the transmission delay Td27 between the range 732 and the maximum transmission delay range 737. For example, Tw2>Td27. In addition, the cycle Tf2 between the two A2s is determined depending on the assumed time Tr2 required for the walking assistance device 300 in the range 732 to move to the roadway 701. For example, Tf2<Tr2/2.

As illustrated in FIGS. 55A to 55C, when the pedestrian 340 wearing the walking assistance device 300 in the range 733 is in the transmission permission state and the transmitting is performed to the vehicle of the roadway 701, the walking assistance device 300 performs transmission from the head t1 of the occupied transmission band A3 corresponding to the range 733 (FIG. 55B). Once the transmission is started, the frequency band is occupied until the processing is completed (FIG. 55C). The walking assistance device 300 that is in the other range using the same frequency band receives the transmission of t2 (occupied transmission period A3) from the transmission start time t1 to detect the use of the band, and shifts to the transmission prohibition state. As long as the transmission prohibition timer expires or transmission permission from the route assignment server is not received, the transmission prohibition state is continued.

[Supplementary Note 1]

A transportation system includes a vehicle that is connected to communicate with a network in radio communication and performs automatic driving, and a route assignment server that is connected to communicate with the vehicle through the network and calculates a traveling route of the vehicle. The route assignment server has a function of estimating the influence on traffic based on a vehicle state, and if it is determined by the estimation that the vehicle becomes an obstacle to traffic, the route assignment server performs processing corresponding to the obstacle.

The vehicle has a self-diagnosis function, and if an abnormality is detected as a result of the self-diagnosis, a notification corresponding to the abnormal condition is transmitted to the route assignment server.

If it is determined that there is a danger of a passenger in a vehicle forcedly parking on a road based on the state of the vehicle, the route assignment server selects an evacuation vehicle from vehicles traveling in the vicinity of the vehicle.

The vehicle receives the road assignment for the nearby vehicle in addition to the road assignment for the vehicle by the route assignment server.

The vehicle measures the position of the nearby vehicle, compares the measured position with the road assignment of the nearby vehicle, and notifies this effect to the route assignment server.

The route assignment server identifies the abnormal vehicle based on the notification based on the measurement of the position of the nearby vehicle and the comparison of the road assignment of the nearby vehicle.

The route assignment server identifies the abnormal vehicle based on the notification based on the measurement of the position of the nearby vehicle and the comparison of the road assignment of the nearby vehicle.

The route assignment server selects a vehicle, of which the traveling is controlled instead of the abnormal vehicle, from vehicles traveling in the vicinity of the abnormal vehicle.

The route assignment server requests a server that controls a base station or a base station for a communication means exclusively used between the abnormal vehicle and the vehicle that performs the travel control instead of the abnormal vehicle.

When the parked/stopped vehicle is detected, the vehicle acquires information identifying the parked/stopped vehicle and notifies the route assignment server of the position and identification information of the parked/stopped vehicle.

The route assignment server estimates whether the parked/stopped vehicle causes a traffic trouble based on the detection of the parked/stopped vehicle, and instructs the movement of the parked/stopped vehicle if it is determined to cause the traffic trouble.

When the route assignment server instructs the movement of the parked/stopped vehicle, the route assignment server notifies the destination to the use reserving person of the parked/stopped vehicle.

When the route assignment server instructs the movement of the parked/stopped vehicle, the route assignment server notifies the destination to a final use person of the parked/stopped vehicle.

The vehicle has an RF-ID configured to notify the identifier of the vehicle.

The vehicle has a function of notifying an identifier of the vehicle by vehicle-to-vehicle communication.

The route assignment server makes a band reservation for use in information notification of the vehicle to the base station or the server that controls the base station, and notifies the acquired band to the vehicle.

In the route assignment server, the band reservation used for the information notification of the vehicle to the base station or the server that controls the base station includes the time to use the band and the vehicle position.

Therefore, it is possible to respond to the automatically driven vehicle that becomes obstacles on road traffic at an early stage, and the influence on effective use of the space of the road is suppressed to be low.

[Supplementary Note 2]

A transportation system includes a vehicle that is connected to communicate with a network in radio communication and performs automatic driving, a route assignment server that is connected to communicate with the vehicle through the network and calculates a traveling route of the vehicle, and a walking assistance device configured to assist a walking of a passenger. The walking assistance device includes a movement detection unit configured to detect a walking movement of a user, a walking assistance power unit configured to assist walking, a balance correction unit configured to correct the balance so as not to fall down, a movement detection unit configured to detect a movement of the user, and a control unit configured to control the walking assistance power unit based on an instruction from the balance correction unit. The walking assistance device includes a first radio communication unit configured to perform communication connection to a network by radio communication, a position measurement unit configured to measure a current position, a movement prediction unit configured to predict movement based on the control by the control unit, a contact determination unit configured to determine the risk of contact with the vehicle based on the prediction by the movement prediction unit and the travel route of the vehicle generated by the route assignment server acquired by the first radio communication unit, an avoidance method generation unit configured to generate at least one avoidance method for avoiding contact, a damage degree estimation unit configured to estimate a damage degree when the avoidance method generated by the avoidance method generation unit is used for prediction by the movement prediction unit and the traveling route of the vehicle, an avoidance method selection unit configured to select an avoidance method based on a damage condition estimated by the damage degree estimation unit, and an avoidance control unit configured to control the walking assistance power unit based on the avoidance method selected by the avoidance method selection unit.

The walking assistance device has a second radio communication unit configured to perform communication connection with the vehicle by radio communication and a band acquisition unit configured to acquire a transmission band used by the second radio communication unit. The band acquisition unit acquires a transmission band, of which the use is permitted, based on the transmission band assignment information received by the first radio communication unit and the position information measured by the position measurement unit, and the second radio communication unit performs transmission to the vehicle by using the acquired transmission band.

The transmission band assignment information has an assignment band and a transmission start timing for each application range (center position, width coefficient).

The walking assistance device includes: a risk level derivation unit configured to derive a risk level degree at the measurement position based on the transmission band assignment information and the position information measured by the position measurement unit, and a movement restriction unit configured to give a restriction to the walking assistance by the walking assistance power unit. The movement restriction unit instructs restriction to movement control based on the movement detection unit among the control by the control unit according to the risk level derived by the risk level derivation unit.

In the use of the transmission band acquired by the transmission band assignment information, the walking assistance device has a transmission prohibition state and a transmission permission state.

If the use is detected by a device other than the device in the transmission band described in the transmission bandwidth allocation information, the walking assistance device shifts to a transmission prohibition state.

When the transmission permission is received from the base station, the walking assistance device shifts to the transmission permission state.

The walking assistance device activates a transmission prohibition timer when shifting to the transmission prohibition state.

The walking assistance device shifts to the transmission permission state when the transmission prohibition timer expires.

The walking assistance device restarts the transmission prohibition timer when receiving the transmission prohibition continuation from the base station.

In the case of the transmission prohibition state, the movement restriction unit instructs restriction to movement control based on the movement detection unit among the control by the control unit according to the risk level derived by the risk level derivation unit.

The avoidance method generated in the avoidance method generation unit jumps onto the traveling vehicle.

The avoidance method generated by the avoidance method generation unit stops the function of the balance correction unit and performs falling.

The avoidance method generated by the avoidance method generation unit stops the function of the balance correction unit and makes contact with surrounding fixed objects.

The avoidance method generated by the avoidance method generation unit performs an operation in which falling inevitably occurs in the balance correction unit.

The traveling route of the vehicle generated by the route assignment server includes an identifier indicating vehicle body information of the vehicle.

The vehicle body information includes movement performance, danger avoidance ability, shape, hardness.

In the case of the transmission prohibition state, the avoidance method selection unit excludes, from an option, jumping onto the traveling vehicle as an avoidance method.

If the avoidance method selected by the avoidance method selection unit jumps onto the traveling vehicle, the walking assistance device notifies the vehicle of the avoidance method by using the second radio communication unit.

The avoidance method of notifying the vehicle has a shape (identifier) corresponding to the walking assistance device, a scale, a gravity center position, and a posture direction for each minute time period.

The avoidance method of notifying the vehicle has an occupied area of the vehicle for each minute time period.

The walking assistance device has a restraint unit configured to restrain the freedom of the hands and arms of the user of the walking assistance device and a damage reduction unit configured to reduce damage to the user's body due to a collision or the like. The avoidance control unit instructs restraint to the restraint unit based on the selected avoidance method, and instructs the damage reduction unit to reduce the damage based on the timing at which the impact on the user occurs.

The avoidance method selection unit excludes the avoidance method from the option when it is estimated that the avoidance method is difficult to travel according to the vehicle traveling information by the estimation by the damage degree estimation unit.

When the avoidance method is acquired from the avoidance method selection unit, the avoidance control unit transmits, to the route assignment server, a rescue request including the damage degree estimated by the damage degree estimation unit with respect to the selected route avoidance method.

The danger degree includes the damage degree of the user of the walking assistance device, the damage degree of the vehicle, the damage degree of the surrounding pedestrian, and the damage degree of the passenger of the vehicle.

The walking assistance device has a communication unit that is attached to a body of a user of the walking assistance device and communicates with a body measurement device that measures the state of the body, and the avoidance control unit notifies the route assignment server of information of the physical measurement device acquired by the communication unit.

If the movement restriction unit determines that the power held by the internal battery of the walking assistance device is lower than the power required for the avoidance movement, the movement restriction unit instructs restriction to the movement control based on the movement detection unit among the controls by the control unit according to the risk degree derived by the risk degree derivation unit.

The vehicle includes a passenger restraint unit configured to restrict a passenger and a seat position control unit configured to control a position of a seat on which the passenger sits. Upon receiving the avoidance method, the control unit of the vehicle instructs the passenger restraint unit to restrain the passenger and instructs the seat position control unit to move the seat of the passenger based on the contact position of the walking assistance device according to the avoidance method.

At the transmission start timing with the frequency assignment band for each application range notified by the transmission band assignment information, the frequency band assigned to the application range including the position by the position measurement and the transmission start timing in different application ranges to which the same frequency band is assigned with respect to the transmission start timing are determined based on the transmission delay time between two application ranges.

At the transmission start timing and the frequency assignment band for each application range notified by the transmission band assignment information, the assignment cycle of the transmission start timing assigned to the application range including the position by the position measurement is determined based on the assumed movement time from the application range to the traveling region of the vehicle.

At the frequency assignment band and the transmission start timing for each application range notified by the transmission band assignment information, the width of the application range is determined based on the assumed traveling time to the traveling area of the vehicle.

At the frequency assignment band and the transmission start timing for each application range notified by the transmission band assignment information, the width of the application range is determined based on the traveling condition of the vehicle in the traveling area of the nearby vehicle.

If the rescue request is received, the route assignment server searches for vehicles having a rescue function from the vehicles in the vicinity of the place requiring rescue described in the rescue request, selects the vehicle according to the number of people who need the rescue, and generates route assignment information.

The vehicle instructed to rescue by the route assignment server changes a body color of the vehicle to a color of the rescue vehicle.

If the rescue request is received, the route assignment server sets a substitute vehicle for the vehicle based on the damage degree of the vehicle.

The vehicle has a function of changing the vehicle body color of the inside and outside of the vehicle body, and has a function of comparing with the vehicle body color for specific use and determining whether it is easy to make a mistake. If it is determined that it is easy to make a mistake in the determination function when changing the body color of the inside and outside of the vehicle body, the function of changing the color of the vehicle body does not change to the vehicle body color.

This makes it possible to minimize the damage to the danger of jumping in the elderly who wears the walking assistance device.

### INDUSTRIAL APPLICABILITY

The present invention is useful in road transportation systems.

1. A server device for performing communication with a plurality of vehicles having an automatic driving function through a network, the server device comprising:
a processor configured to assign an area on a road to be traveled by automatic driving to each vehicle as an occupied area,
wherein the processor is further configured to:
determine whether the vehicle is a traffic-obstructing vehicle that becomes an obstacle to traveling according to the assignment of the occupied area, based on information notified from the vehicle and/or another vehicle traveling around the vehicle, and
perform a process corresponding to the obstacle in response to determining that the vehicle is the traffic-obstructing vehicle.

2. The server device according to claim 1, wherein
the processor determines that one vehicle is the traffic-obstructing vehicle in response to receiving, from the one vehicle, a notification indicating an abnormality detected by the one vehicle from self-diagnosis of the one vehicle.

3. The server device according to claim 1, wherein,
if the traffic-obstructing vehicle is stopped and parked, the processor selects an evacuation vehicle that evacuates a passenger of the traffic-obstructing vehicle from among other vehicles traveling around the traffic-obstructing vehicle.

4. The server device according to claim 1, wherein
the processor determines that another vehicle is the traffic-obstructing vehicle in response to receiving, from one vehicle, a notification indicating that the another vehicle traveling around the one vehicle is not traveling in the assigned road area.

5. The server device according to claim 1, wherein
the processor selects a guide vehicle for guiding the traffic-obstructing vehicle from among other vehicles traveling around the traffic-obstructing vehicle.

6. The server device according to claim 5, wherein
the processor requests a base station or a base station control device to set communication between the traffic-obstructing vehicle and the guide vehicle.

7. The server device according to claim 1, wherein
the processor receives, from one vehicle, identification information for identifying a parked/stopped vehicle parking or stopping on a road and information indicating a position of the parked/stopped vehicle, and
if it is determined that the parked/stopped vehicle is the traffic-obstructing vehicle, the processor instructs a movement of the parked/stopped vehicle.

8. The server device according to claim 7, wherein,
when the processor instructs the movement of the parked/stopped vehicle, the processor notifies a use reserving person or a final use person of the parked/stopped vehicle of a destination of the parked/stopped vehicle.

9. The server device according to claim 7, wherein
the identification information is a vehicle identifier notified by an RF-ID tag provided in the parked/stopped vehicle, or a vehicle identifier broadcast by the parked/stopped vehicle by vehicle-to-vehicle communication.

10. The server device according to claim 1, wherein
the processor reserves a radio resource used for notifying the occupied area assigned to each vehicle to a base station or a base station control device, and
the processor notifies the respective vehicles of the reserved radio communication resource.

11. A vehicle control device for being provided in a vehicle having an automatic driving function and controlling the vehicle, the vehicle control device comprising:
a communication unit configured to perform communication with a server device through a network; and
a processor configured to detect another vehicle which becomes an obstacle to traveling according to an assignment of an occupied area from the server device,
wherein the occupied area is an area on a road to be traveled by automatic driving, and
the processor notifies the server device of information about the other vehicle.

12. The vehicle control device according to claim 11, wherein
the processor acquires, from the server device, information indicating assignment of an occupied area of a vehicle around the vehicle,
the processor measures a position of the surrounding vehicle, and
if it is determined that the surrounding vehicle is not traveling in the occupied area, the processor notifies the server device of information about the surrounding vehicle.

13. The vehicle control device according to claim 11, wherein
the processor notifies the server device of identification information for identifying a parked/stopped vehicle parking or stopping on a road and information indicating a position of the parked/stopped vehicle.

14. A walking assistance device comprising:
a walking assistance power unit configured to assist a walking of a user;
a communication unit configured to perform communication with a server device through a network; and
a processor configured to acquire, from the server device, assignment information indicating an area on a road on which a vehicle travels by automatic driving,
wherein the processor predicts a movement of the user,
the processor determining whether the user contacts the vehicle based on the prediction result of the movement and the assignment information, and
in response to determining that the user will contact the vehicle, the processor controls the walk assistance power unit so that the user will not contact the vehicle, and/or performs notification to the vehicle.
